(19) United States
(12) Patent Application Publication
(10) Pub. No.: US 2026/0039177 A1
(43) Pub. Date: Feb. 5, 2026

(54) ADDING HOMOPOLAR ROTORS IN SERIES WITHOUT SLIDING CONTACTS

(71) Applicant: NextPower360 Co., Leicester, NC (US)

(72) Inventor: Benedetto Anthony IACOVELLI, Leicester, NC (US)

(21) Appl. No.: 19/289,898

(22) Filed: Aug. 4, 2025

Related U.S. Application Data
(60) Provisional application No. 63/679,511, filed on Aug. 5, 2024.

(51) Int. Cl. H02K 31/00

(52) U.S. Cl. CPC H02K 31/00

(57) ABSTRACT

A dynamoelectric machine including stator layers spaced radially apart from one another, rotor layers provided between adjacent ones of the stator layers and rotatable through a fixed magnetic field generated by the stator layers, electrical connectors to electrically connect axial ends of adjacent ones of the rotor layers in series, parallel, or a combination of series and parallel, and at least one flux return mitigation assembly to interact with flux of the fixed magnetic field generated by the stator layers. A portion of one of the electrical connectors passes through an empty center portion of the at least one flux return mitigation assembly. The at least one flux return mitigation assembly includes magnetic structures extending between a gap between the stator layers that are spaced radially apart from one another.

### CROSS-REFERENCE TO RELATED APPLICATIONS

The present application claims priority to U.S. Patent Application No. 63/679,511, filed on Aug. 5, 2024, the entire contents of which are hereby incorporated herein by reference.

### BACKGROUND OF THE INVENTION

### 1. Field of the Invention

The present invention relates to novel methods, structures, and systems for improving generators and motors. More specifically, the present invention relates to electrically connecting two or more homopolar rotors in series in a manner that does not require the use of sliding contacts.

### 2. Description of the Related Art

Homopolar generators and motors generally require sliding contacts to collect the energy induced in the rotors. Unfortunately homopolar generators usually produce power that, while having very high amperage, has such a deleteriously low voltage that the electrical resistance from sliding contacts offsets a large percentage of the power made in the generator. The measured output beyond the sliding contacts may be only a small fraction of the power the generator can produce internally before the resistance of the sliding contact. A typical homopolar generator assembly may make 125,000 amps but only ¼th of a volt. If the contact resistance drops voltage by ⅕th of a volt only 1/20th of the potential power is extracted from the homopolar generator assembly.

Sliding contacts have many other disadvantages, including wear, maintenance requirements and they give off electrically conductive dust inside of an electrical machine.

Many investigators have tried various ways of connecting 2 or more homopolar rotors in series to increase the voltage. If the homopolar motor/generator assembly has sliding contacts that operate in series, their resistance adds, increasing the problem proportionately to its solution. Non-sliding contacts such as a wire physically connected to the rotors do not have the sliding contact resistance losses, but often encounter a different problem.

### SUMMARY OF THE INVENTION

To overcome the problems described above, example embodiments of the present invention provide alternative and new ways of electrically connecting rotors of a homopolar motor/generator assembly.

According to an example embodiment of the present invention, a dynamoelectric machine includes stator layers spaced radially apart from one another, rotor layers provided between adjacent ones of the stator layers and rotatable through a fixed magnetic field generated by the stator layers, electrical connectors to electrically connect axial ends of adjacent ones of the rotor layers in series, parallel, or a combination of series and parallel, and at least one flux return mitigation assembly to interact with flux of the fixed magnetic field generated by the stator layers. A portion of one of the electrical connectors passes through an empty center portion of the at least one flux return mitigation assembly. The at least one flux return mitigation assembly includes magnetic structures extending between a gap between the stator layers that are spaced radially apart from one another.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

FIG. 1 shows a perspective view of an axial end of a Faraday drum homopolar machine according to an example embodiment of the present invention.

FIG. 2A shows a radial direction cross section of a cylindrical machine according to an example embodiment of the present invention.

FIG. 2B shows flux returns and flux density of one lateral side portion of the radial cross section of the cylindrical machine of FIG. 2A.

FIG. 3A shows flux returns and flux density of a cross section of a cylindrical machine according to an example embodiment of the present invention.

FIG. 3B shows flux returns and electric potential of a cross section of a cylindrical machine according to an example embodiment of the present invention.

FIG. 4A shows flux returns and a flux density of a cross section of a cylindrical machine according to an example embodiment of the present invention.

FIG. 4B shows flux returns and a flux density of a cross section of a cylindrical machine according to an example embodiment of the present invention.

FIG. 5A shows flux returns and a flux density of a cross section of a cylindrical machine according to an example embodiment of the present invention.

FIG. 5B shows flux returns and electric potential of a cross section of a cylindrical machine according to an example embodiment of the present invention.

FIG. 6 shows flux returns and a flux density of a cross section of a cylindrical machine according to an example embodiment of the present invention.

FIG. 7 shows flux returns and a flux density of a cross section of a cylindrical machine according to an example embodiment of the present invention.

FIG. 8 shows flux returns and a flux density of a cross section of a cylindrical machine according to an example embodiment of the present invention.

FIG. 9A shows flux returns and a flux density of a cross section of a cylindrical machine according to an example embodiment of the present invention.

FIG. 9B shows flux returns and electric potential of a cross section of a cylindrical machine according to an example embodiment of the present invention.

FIG. 10 shows flux returns and electric potential of a cross section of a cylindrical machine according to an example embodiment of the present invention.

FIG. 11 shows an isometric view of flux returns and a conductor path of a cylindrical machine according to an example embodiment of the present invention.

FIG. 12 shows an isometric view of an unshielded conductor path of a cylindrical machine according to an example embodiment of the present invention.

FIG. 13 shows flux returns and electric potential of a cross section of a cylindrical machine according to an example embodiment of the present invention.

FIG. 14A shows flux returns and a flux density of a cross section of a cylindrical machine according to an example embodiment of the present invention.

FIG. 14B shows flux returns and a flux density of a cross section of a cylindrical machine according to an example embodiment of the present invention.

FIG. 15A shows flux returns and a flux density of a cross section of a cylindrical machine according to an example embodiment of the present invention.

FIG. 15B shows flux returns and a flux density of a cross section of a cylindrical machine according to an example embodiment of the present invention.

FIG. 16A shows flux returns and a flux density of a cross section of a cylindrical machine according to an example embodiment of the present invention.

FIG. 16B shows flux returns and an electric potential of a cross section of a cylindrical machine according to an example embodiment of the present invention.

FIGS. 17A-17C show flux returns and electric potentials of a cross section of a cylindrical machine according to an example embodiment of the present invention.

FIG. 18 shows flux returns and a flux density of a cross section of a cylindrical machine according to an example embodiment of the present invention.

FIG. 19A shows flux returns and an electric potential of a cross section of a cylindrical machine according to an example embodiment of the present invention.

FIG. 19B shows flux returns and an electric potential of a cross section of a cylindrical machine according to an example embodiment of the present invention.

FIG. 20 shows flux returns and a flux density of a cross section of a cylindrical machine according to an example embodiment of the present invention.

FIGS. 21A-21C show flux returns and electric potential of a cross section of a cylindrical machine according to an example embodiment of the present invention.

FIGS. 22A and 22B show flux returns and electric potential of a cross section of a cylindrical machine according to an example embodiment of the present invention.

FIGS. 23A-23D show flux returns and electric potential of a cross section of a cylindrical machine according to an example embodiment of the present invention.

FIGS. 24A-24D show flux returns and electric potential of a cross section of a cylindrical machine according to an example embodiment of the present invention.

FIG. 25 show flux returns and an electric potential of a cross section of a cylindrical machine according to an example embodiment of the present invention.

FIG. 26 shows a cross section of a cylindrical machine according to an example embodiment of the present invention.

FIG. 27 shows a perspective view of an axial end of a Faraday drum homopolar motor according to an example embodiment of the present invention.

FIG. 28 shows a cross section of a cylindrical machine according to an example embodiment of the present invention.

FIG. 29 shows a cross section of a cylindrical machine according to an example embodiment of the present invention.

FIG. 30 shows a cross section of a cylindrical machine according to an alternate example embodiment of the present invention.

FIG. 31 shows radial and axial cross sections of a cylindrical machine according to another alternate example embodiment of the present invention.

FIG. 32A shows a perspective view of a Faraday drum homopolar motor according to an example embodiment of the present invention.

FIG. 32B shows a perspective view of a Faraday drum homopolar motor according to an example embodiment of the present invention

FIGS. 33A-33D show flux returns and electric potential of a cross section of a cylindrical machine according to an example embodiment of the present invention.

FIG. 34 shows flux returns and an electric potential of a cross section of a cylindrical machine according to an example embodiment of the present invention.

FIG. 35 shows flux returns and an electric potential of a cross section of a cylindrical machine according to an example embodiment of the present invention.

FIG. 36 shows flux returns and an electric potential of a cross section of a cylindrical machine according to an example embodiment of the present invention.

FIG. 37 shows flux returns and an electric potential of a cross section of a cylindrical machine according to an example embodiment of the present invention.

FIG. 38 shows flux returns and an electric potential of a cross section of a cylindrical machine according to an example embodiment of the present invention.

### DETAILED DESCRIPTION OF EXAMPLE EMBODIMENTS

Example embodiments of the present invention will now be described with reference to the Drawings.

Example embodiments of the present invention are usable for dynamoelectric machines including electric motor applications as well as generator applications (e.g., the example embodiments of the present invention are applicable for any type of dynamoelectric machine). For the purpose of this disclosure, the focus will be on drum type example embodiments of homopolar type generators and motors, but the principles and techniques according to example embodiments disclosed herein apply to all homopolar/designs in ways that are clear to those skilled in the art.

As discussed briefly above, many investigators have tried various ways of connecting 2 or more homopolar rotors in series to increase the voltage. If the unit has sliding contacts that operate in series, the resistance of the sliding contacts adds, increasing the problem proportionately to its solution. Non-sliding contacts such as a wire physically connected to the rotors do not have the sliding contact resistance losses, but often encounter a different problem.

Because of the Faraday paradox, the magnetic field in many homopolar generators can be thought of as stationary even when the magnets that make the field are rotating. A connector/wire attached to the moving rotor layer moves through that stationary field and therefore experiences a voltage/emf. When the connector/wire passes through the reversed direction returning flux, the voltage created in the connector/wire can be essentially equal and opposite to the emf/voltage created in the rotor-canceling the output of all but one rotor no matter how many are connected in series.

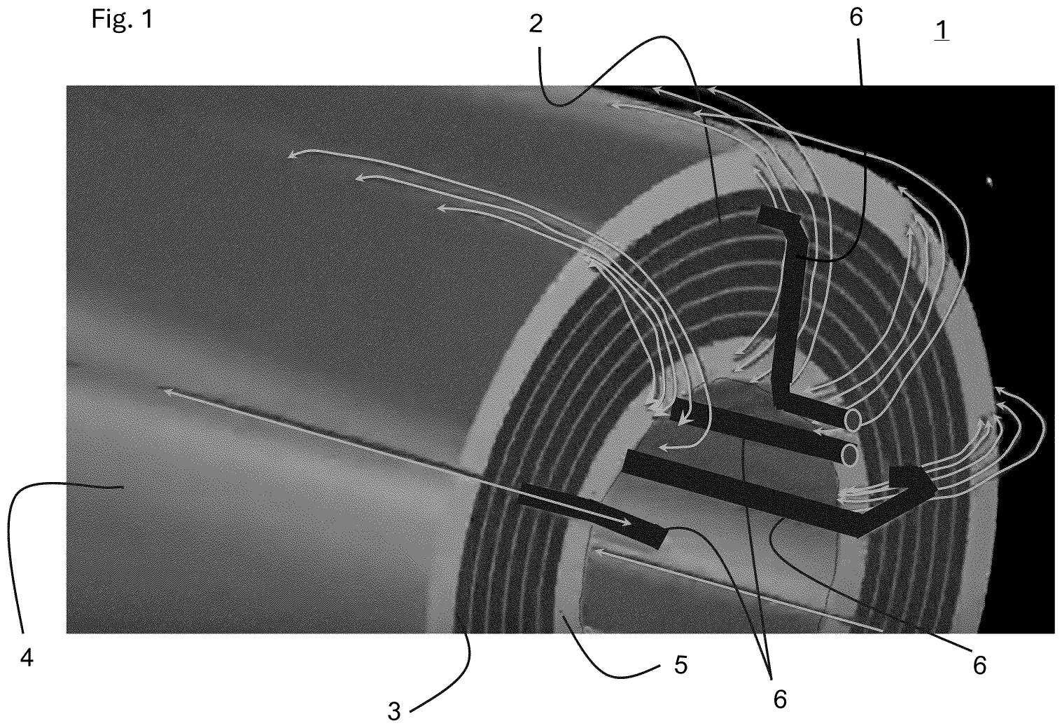

FIG. 1 shows an example embodiment of a novel Faraday paradox drum homopolar machine 1 according to an example embodiment of the present invention. The Faraday paradox drum homopolar machine 1 preferably includes, for example, five cylindrical rotors 2 sandwiched between six magnet layers 3 (e.g., “stator” layers) that define a stationary radial magnetic field, because of the Faraday paradox, the magnetic field functions as if it were stationary even when the magnet layers 3 are rotating together with the cylindrical rotors 2. The cylindrical rotors 2 and magnet layers 3 are preferably housed within a hollow tube casing which includes an outer cylindrical housing/yoke 4, an inner cylindrical housing/yoke 5, and an empty center. The locations of the flux return are shown as gray flux lines in FIG. 1. The drum homopolar machine 1 preferably further includes connectors/wires 6 which are electrically hard connected (e.g., fixedly connected as opposed to sliding connected) to the rotors through, for example, welding, brazing, etc. The connectors/wires 6 are structured to pass through the empty center to connect one axial end of a first one of the rotors 2 to a far axial end of another one of the rotors to link them in series, parallel, or a combination of series and parallel. There are preferably disk shaped yoke end caps that connect the inner and outer cylindrical yokes 4 and 5 on each end (not pictured here).

When this entire apparatus spins axially the stationary flux field does not rotate. As the rotors rotate through the stationary radial field within the cylindrical stack of rotors/magnets that make up the body of the generator, an emf is induced that causes a voltage pushing current toward one axial end of the rotors. (There are other embodiments in which the magnetic field polarity around the different rotors are in different directions, making the EMF towards alternate ends of the different rotors. For simplicity the below discussion will focus on the variants in which the EMF in all rotors pusses in the same axial direction.

In motor applications the rotor is best considered as a series of axial conductors, insulated laterally from each other. These are described in detail in related application. In generators, a wire/electrical connector picks up the current from one rotor axial end, passing, perhaps, through the axial center of the machine to connect with a different rotor layer on the far axial end. (There are also other routes for the wire, but through the center is discussed for minimal field interaction.) But for a single problem, this would be an ideal way of connecting the rotors in series to add the voltages.

The problem, as shown in FIG. 1, comes from the wires/connectors 6 spinning with the cylindrical generator body. As the wires 6 are dragged through the two reverse flux fields (one on each axial end of the cylindrical body), a substantially equal and opposite EMF is generated in the wire 6 effectively canceling the net current flow from the additional rotor layers 2.

The origin and insertion of each wire 6 is at the rotor 2 in the center of both sides' stator 3 flux loops. The path the wire 6 travels, of necessity, crosses the walls of both flux loops. Simply re-routing the wire 6 cannot solve this problem. There is no alternative path for the wire 6 that does not cross the “flux box” walls that surround the wires' 6 origin and insertions at the axial ends of the rotors 2.

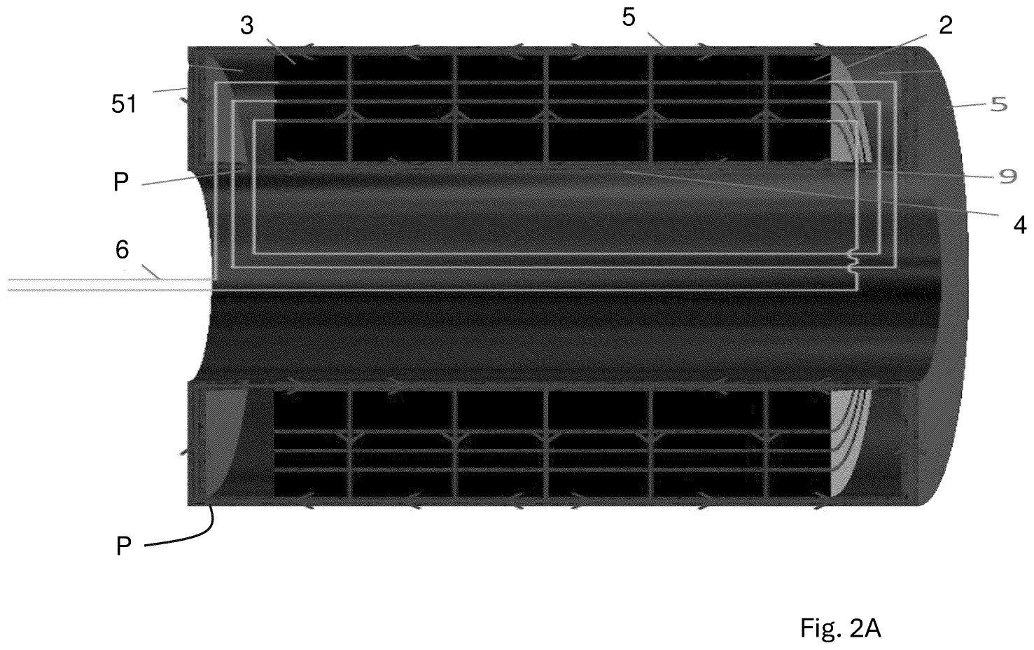

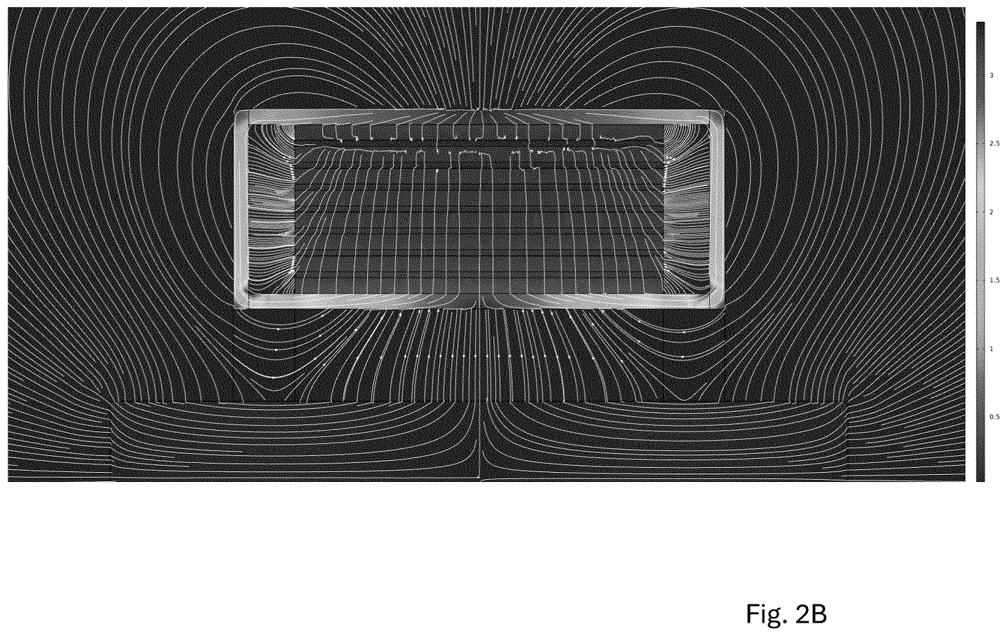

FIG. 2A shows a cross section of an example embodiment of a dynamoelectric machine of the present invention in which flux paths P (indicated with directional arrows) make two taurus shaped closed ‘boxes,’ each of which surrounds one end of the rotors 2. The wires 6 connect the rotor layers 2 in series. The wires/connectors 6 pass from within the center of one side's flux path box, coursing through the two flux boxes' walls to get to the center of the other flux box to reconnect with the rotors 2. The problem area is depicted where the wires 6 cross the flux lines of the path P. Each time the wire transects the return flux path it experiences an opposite voltage induction in the wire 6 which cancels out the addition of half of an additional rotor's voltage. Because the wire 6 transverses two flux box walls, the entire voltage of the additional rotor is effectively canceled.

In FIG. 2A, the layered stator magnet layers 3 create magnetic flux that passes radially through the rotor layers 2, in this case, toward the periphery of the cylinder. The return flux is picked up by outer yoke 5 and transmitted through to the closest sidewall 51 and back to the south pole of the magnets 3 via the inner flux return cylinder 4. The wires/connectors 6 pass through a hole in the inner flux return 4 at points 9.

The flux path P bifurcates into 2 taurus shapes with closed box rectangular cross sections. The interior of the flux path box-like cross section is where the wires 6 attach to the rotors 2. At points 9 the rotating wires 6 transect the most of the stationary return flux, creating reverse EMF. There are many other permutations and shapes for the parts or system, but in function they are analogous to the example shown in FIG. 2A. Because flux is always a closed loop and the connectors 6 pass through all the return flux, an equal and opposite EMF voltage is created in the connector as is created in that rotor 2.

FIG. 2B depicts flux returns with side wall end caps, with the magnetic flux creating closed loop “boxes” that encircle each end of the rotors and that the electrical rotor connectors would have to pass through the walls of both boxes to connect with the opposite end of a second rotor.

As shown in FIG. 2A, there is no way to get from inside one flux box to the inside of the other red flux box without crossing the walls of each box and when the connectors 6 cross the return flux and opposite voltage is induced. Note that, even though it is not shown in FIG. 2B, the inner magnets of the stator layers 3 should be stronger than the outer layers in proportion to their circumference and the inner flux return yoke 5 should be thicker and/or more permeable than the outer flux return yoke 4 in the same ratio.

The inventor of the present disclosure has discovered a variety of novel alternative solutions to the arrangement of FIGS. 1-2B which offer different efficacies in solving the flux return reverse voltage problem. Example embodiments of the present disclosure discussed below which correspond to the variety of novel alternative solutions can be combined and altered to adapt to other homopolar configurations without losing the core inventive concept.

Common to the below example embodiments, novel arrangements of magnets are specifically shaped and positioned to function as flux returns to manipulate and help direct the flux return field of the stator layers 3 to minimize, eliminate, or even reverse the backward EMF generated when the connectors travel through the stationary return flux as shown in FIGS. 1-2B. To start, some simplified Finite Element Analysis (FEA) diagrams o show various permutations of the novel solutions will be presented.

For simplification, the FEA version of the stationary taurus radial return flux field of a drum homopolar will be represented as a flat stationary parallel field between 2 stationary large magnets, both with north on the right side face. Smaller magnets which are used to provide a flux return are specifically sized and positioned to change the shape of the return flux field in the region of a circular cross section of a wire (corresponding to wire 6 in FIGS. 1 and 2A) that moves through the stationary flux field. Positioning the smaller magnets in ways that push the stationary field away from the wire or even focally reverse the polarity of the return flux field reduces or even reverses the otherwise deleterious EMF induction in the wire. In the following description, this modification or adjustment of the return flux field away from the wire will be referred to as “active shielding”.

The goal of this group of solutions is to focally remove or alter the direction of the stator return flux field in the region transected by the rotor's electrical connector(s) 6. If the field around the wire 6 can be adjusted to a reverse polarity, instead of producing reverse EMF, a complementary voltage will be induced in the connector 6 that will add to the overall system voltage.

These are a representative sample of the many permutations of how to move and reverse a focal region of a magnetic field's polarity. The specific example embodiments discussed and depicted are not all inclusive to the scope of this invention. A person skilled in the art can extrapolate to other derivative permutations of these solutions that would be covered by this inventive concept. Based on the inventor's considerations, Test 5c (described below) appeared to be the most effective in this series.

The large lateral and small central magnets are all preferably 20 inches tall in this first group of tests and ‘tall’ is referring to a direction coming out of the paper/screen. The conductor is preferably 18 inches tall and centered vertically so it doesn't get into any return flux from any of the magnets while it is moving between them. In this case we are examining the wire in its path toward the top of the paper/screen. We are moving the conductors and the small, shielding magnets' upwards' at a constant and equal velocity of 20 m/s. We are taking a measurement from each of the conductors as they pass through the midpoint of their journey between the big magnets. The shielded conductor experiences flux in the opposite direction of the unshielded one in most of these tests. Cutting through opposite polarity creates an advantageous voltage that adds to our rotor voltage.

In the structures of example embodiments of the present invention, extra voltage can help add extra amperage that would be otherwise hidden by internal resistances.

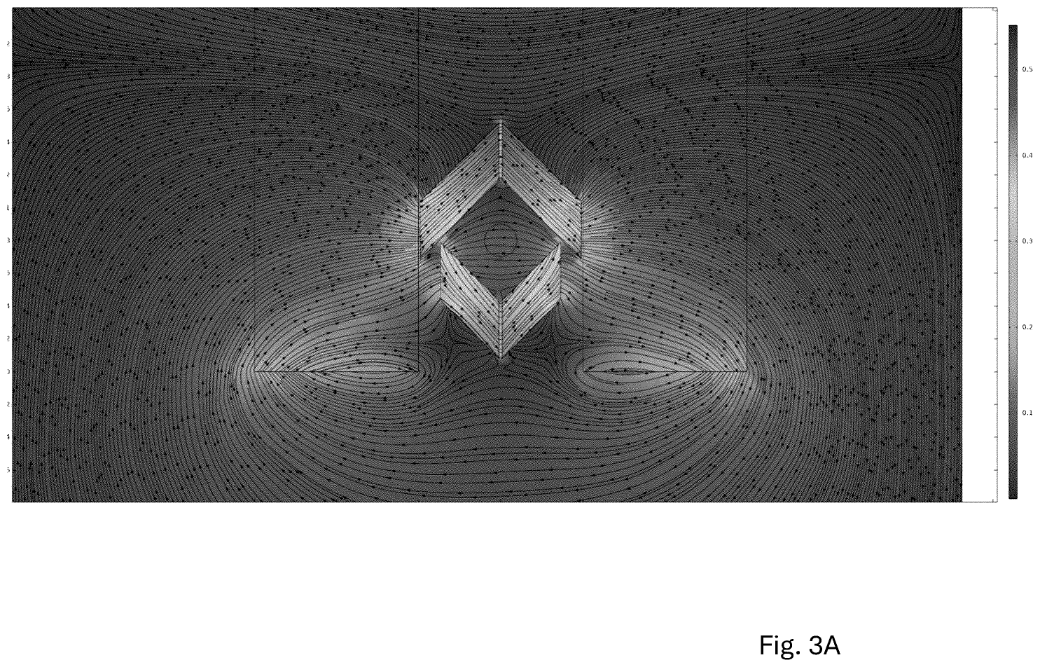

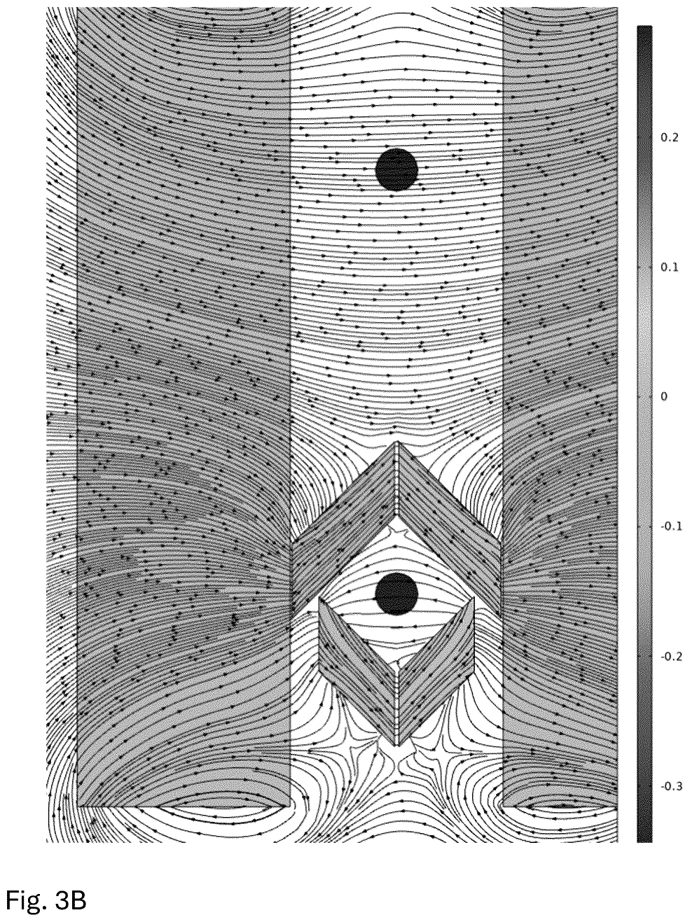

In following example embodiments of the present invention, the following dimensions have been used:
Large magnets (defining stationary magnetic field of, e.g., the stator layers 3): 1×4×20″
Small magnets (defining the flux return): various lengths, 0.25″×20″
Copper wire: 0.2″ diameter×18″ long, centered in height between large and small magnets.
Test 1a: FIG. 3A shows a surface plot of flux density and flux lines (uniform density, for field direction only). Here in FIG. 3B, the same flux lines as those corresponding to the arrows of FIG. 3A, but the surface plot colors are representing Electric Potential. The red dot in FIG. 3B is the cross section of the unshielded conductor, red from deleterious direction voltage. The blue dot is the shielded conductor, blue from advantageous voltage (which in this case is labeled negative.) Results:
Unshielded wire: 271 mV induced in the disadvantageous direction.
Shielded wire: −358 mV induced in the advantageous direction adding to the rotor voltage.
Over/under 629 mV

The end result is that, not only did 271 mV of backward voltage per end of the connecting wire get canceled, but the wire now adds voltage to the rotor output at each end. The over/under is 629 mV per end. As the wire passes through a similar apparatus on both ends, the total positive effect doubles. This structure also suggests other ways of making the conductor pass through a surrounding focal field area of opposite, advantageous polarity.

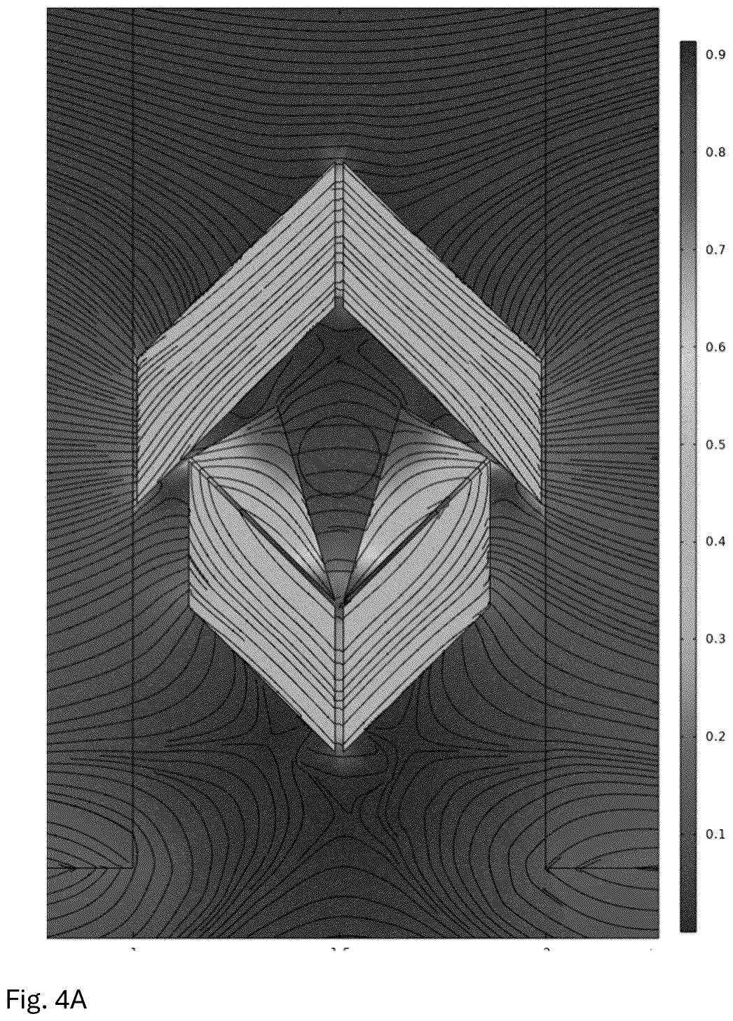

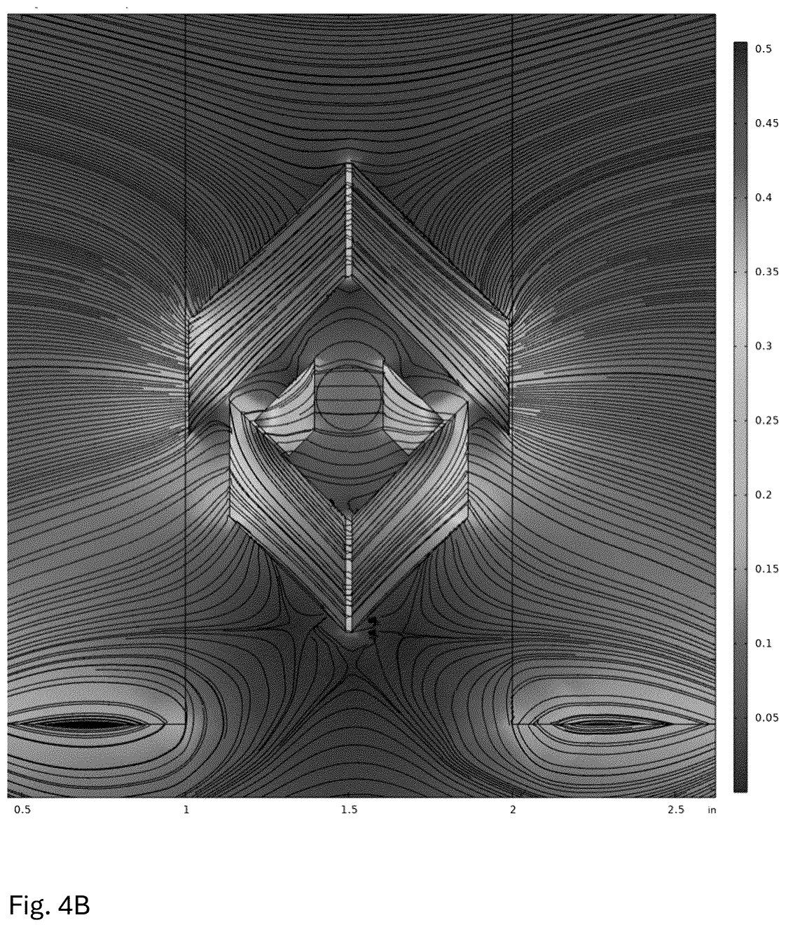

Test 1b: FIG. 4A. This example embodiment includes small added triangle wedges of iron to shorten the amount of empty air gap through the center, but this structure ends up forcing flux to the points of the triangle since it's the closest point.
Shielded −272 mV
Unshielded 291 mV
Over/under 563

Test 1c: FIG. 4B. Modified the above example embodiment to try and create an equal air gap across the return flux and push more flux through the conductor.
Shielded −470 mV
Unshielded 289 mV
Over/under 759 mV

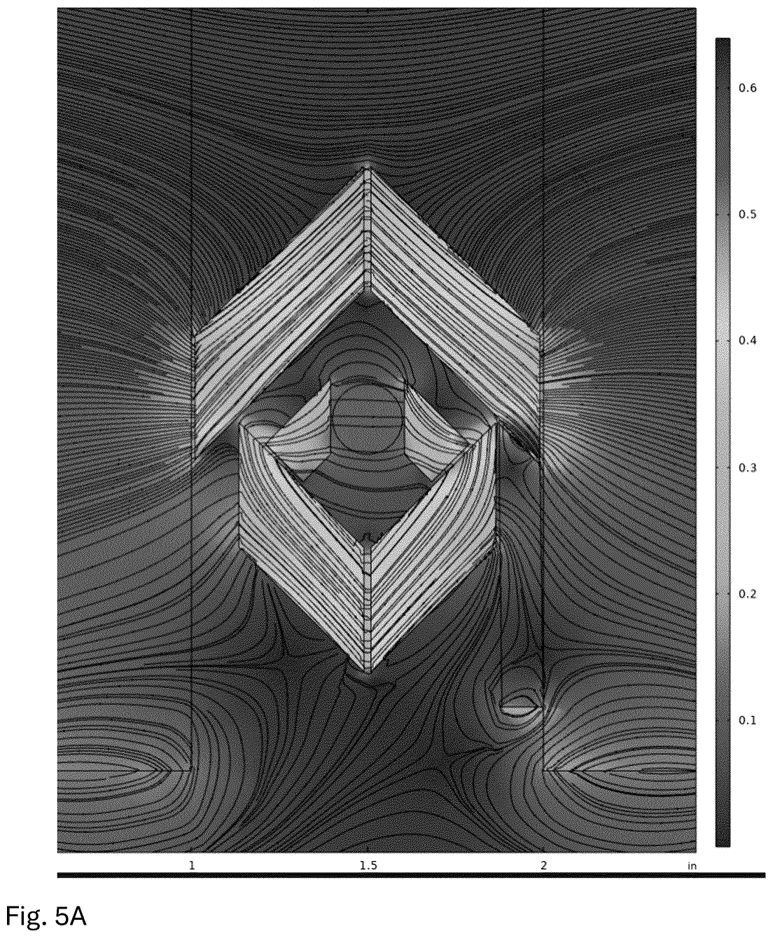

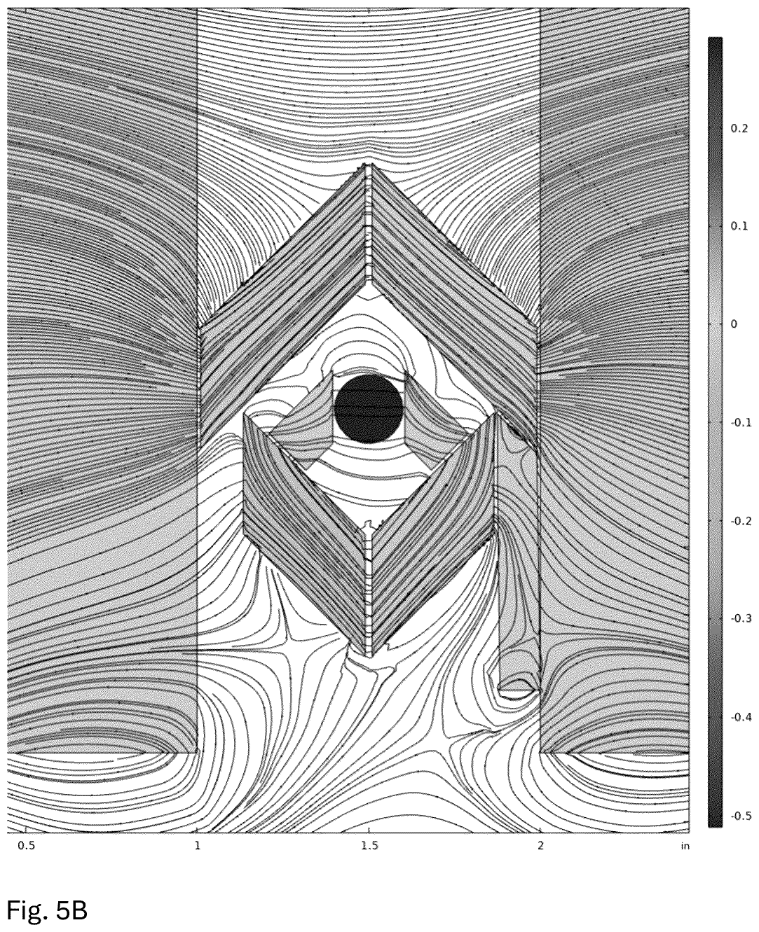

Test 1d: FIGS. 5A and 5B. While it may be difficult to notice in FIG. 5A, there is an additional reverse polarity shielding magnet on the lower right side with North left to block some flux leakage.
Shielded −511 mV
Unshielded 292 mV
Over/under 803 mV

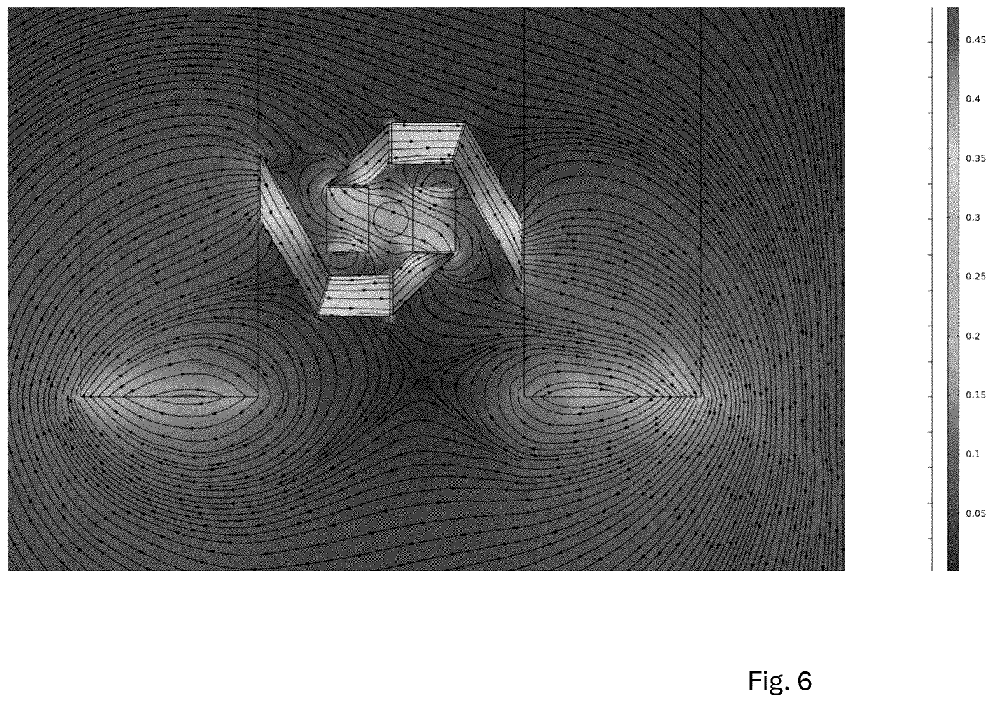

Test 2A: FIG. 6. For this example embodiment, called the spiral galaxy, the polarity of the return flux field is also focally reversed so voltage is induced in the advantageous direction. The flux path of the small magnets spirals around to deliver the large magnet flux to the wires in the opposite direction, plus the small magnets contribute additional flux in this direction. In order to have the needed space, we had to move the large magnets which represent the stator magnets further apart (1 inch to 1.5 inches) so the deleterious induction in the bare wire reduced from 271 mV to 121 mV. The advantageous induction in the spiral galaxy shielded wire went up by a greater amount though from 358 mV to 656 mV.

The shielded conductor made-656 mV of advantageous voltage, presumably because of the much stronger field strength from the chain of magnets each adding to the flux, and because the dearth of magnetically empty airspace caused by the bridging chain of magnets. The over/under advantageous voltage delta went to 777 mV.

This structure can be further improved. One issue is that the most central magnets are not being met by their adjacent magnet on their pole ends. This is causing a bit of a loss in the otherwise clean flux path (note the orange diagonal magnets are joining the light blue central magnets on the lateral side rather than on the pole end.)

There are a variety of ways to improve that. First we will replace the central magnets with iron. This will increase the flux on the wire by having a cleaner path, but reduce it by having less magnets in the chain.

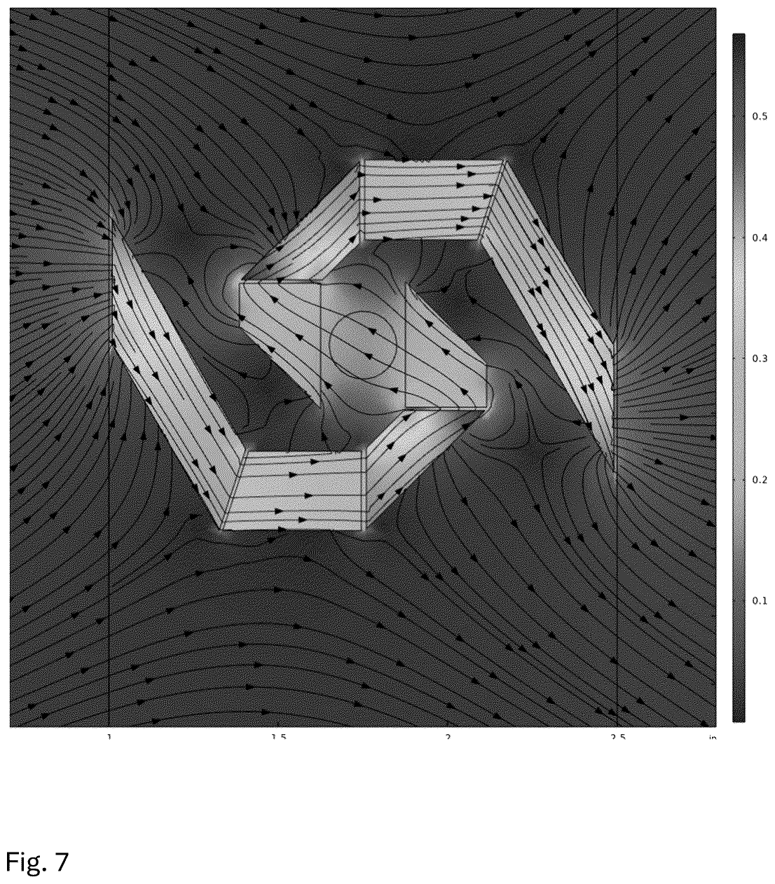

Test 2b: FIG. 7. The central magnets have been replaced by iron polygons, and the outer corners which are remote from the conductor have been removed to reduce flux leakage, but this has caused the flux crossing the wire to shift off the more ideal perpendicular by about 30 degrees.
Iron center pieces with 45 deg angle.
Unshielded—120 mV
Shielded—−570 mV
over/under 690
The flux is at a 45 degree angle which decreases the EMF.

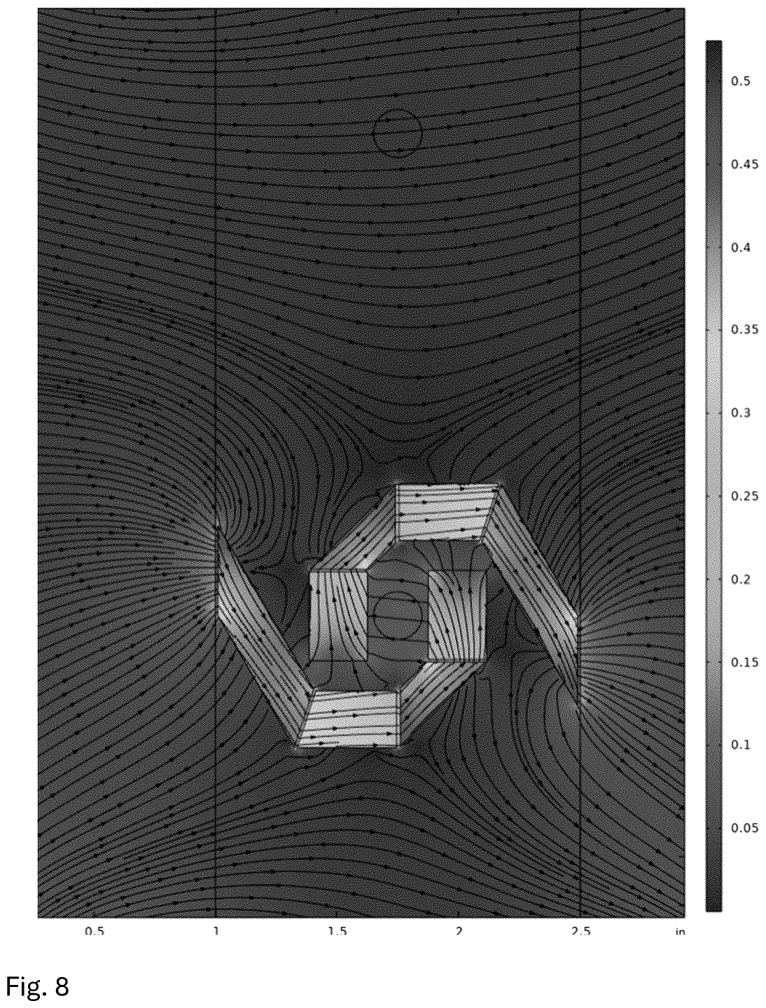

Test 2c: FIG. 8. The iron central pieces are rectangular. Similar test to 2a and 2b. Same layout as 2a but the center squares are iron like in 2b. Flux from the iron pairs to the closest magnets (above and below) leaving the center field around the conductor relatively weak as compared to previous example embodiments.
Shielded −280 mV
Unshielded 120 mV
Over/under 400 mV

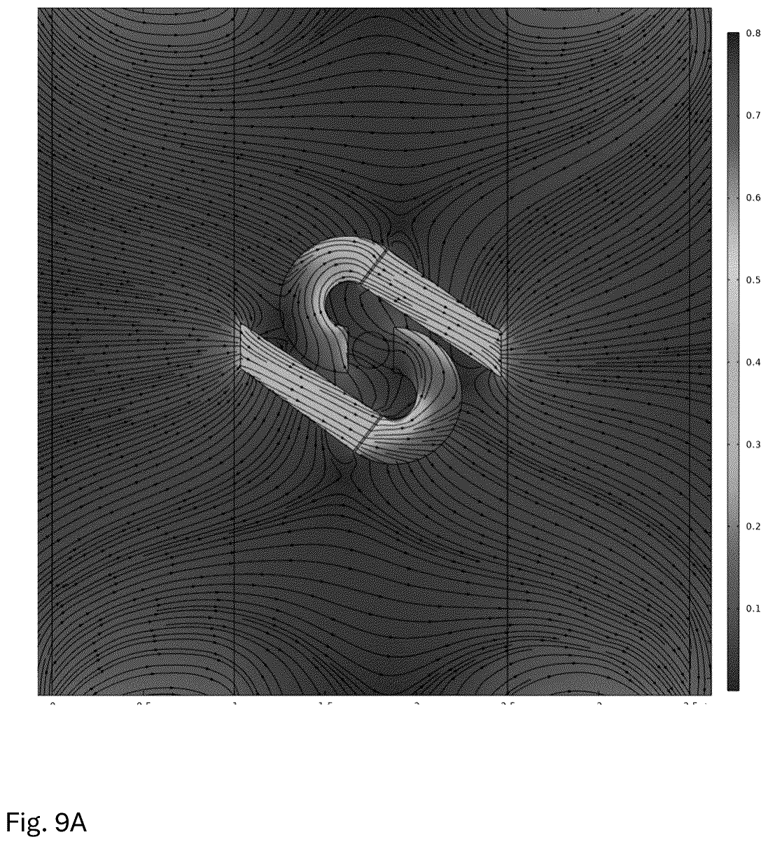

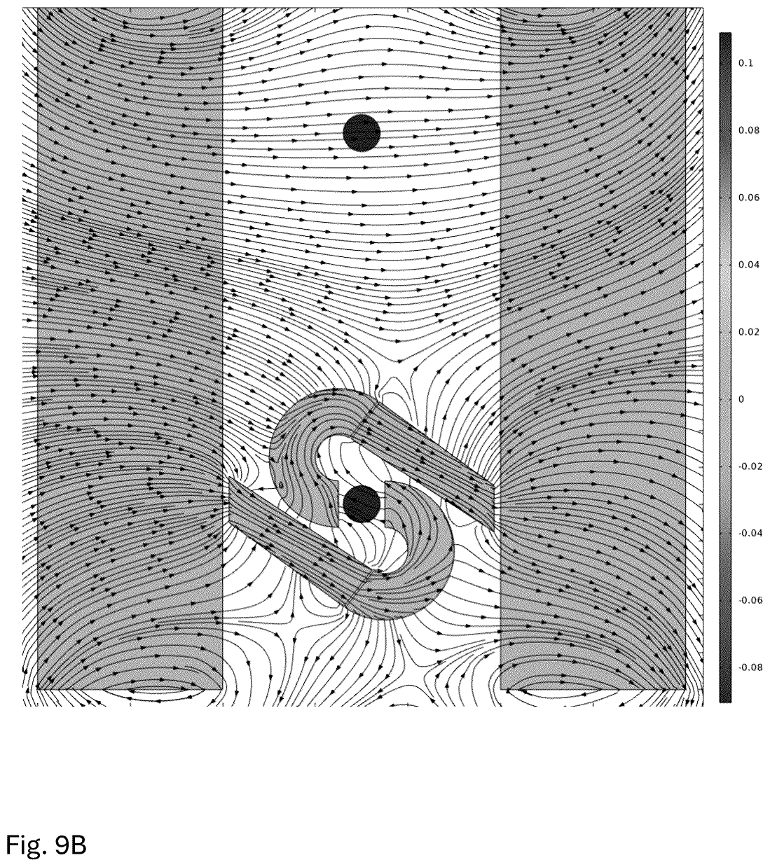

Test 3A: FIGS. 9A and 9B. For this series of example embodiments, the spiral path defined by the flux returns will have smoother curves. This variation uses iron for the curved semi-circle/arc shapes and magnet straight sections. It provides a small benefit, but as expected, much less than it would if it had magnets along the entire route. This is in part due to fewer magnets in the path, and also because a substantial amount of flux is leaking directly across at the bottom curve rather than being directed up and around through the wire.

Also a good deal of extraneous flux is entering at the upper curve. Increasing the space, or perhaps a diamagnetic material might help with that, as would making the sweep a magnet, rather than iron.
Unshielded is 120 mV
Shielded is −90 mV
Over/under 210 mV

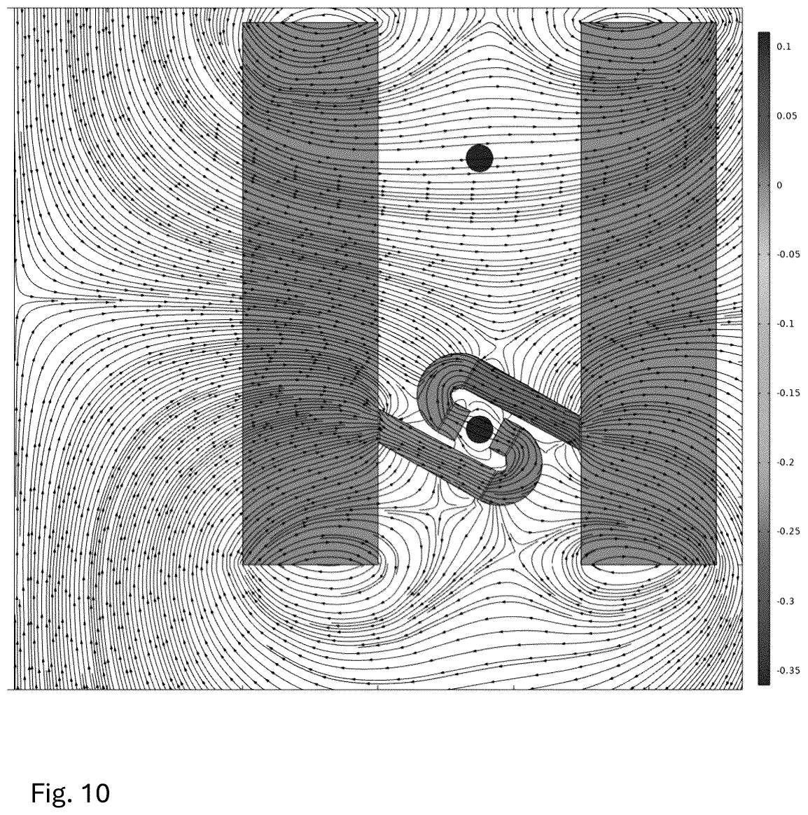

Test 3b: FIG. 10. Small central magnets have been added to the iron curve to direct more of the flux across the wire. The addition of small central magnets has greatly increased the advantageous induction.
Unshielded is 121 mV
Shielded is −721 mV
Over/under is 842 mV improvement
It would do better with horizontal center flux.

For the rest of these series of tests of example embodiments of the present invention, we have moved the large magnets which correspond to the stator field back to 1 inch apart and we have changed the path of the conductor 6 to have it bend leftward at the top and come through a hole which extends through, for example, ones 80′ and 81′ of the small magnets 80-82, 80′, and 81′. This incorporates the part of the wire that bends to connect to the rotor layers 2.

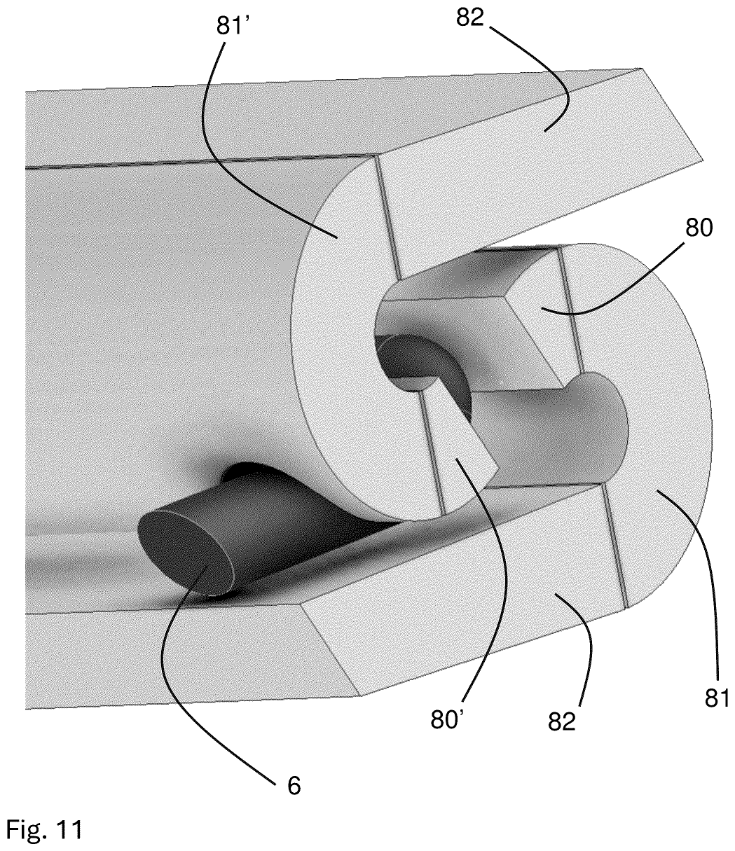

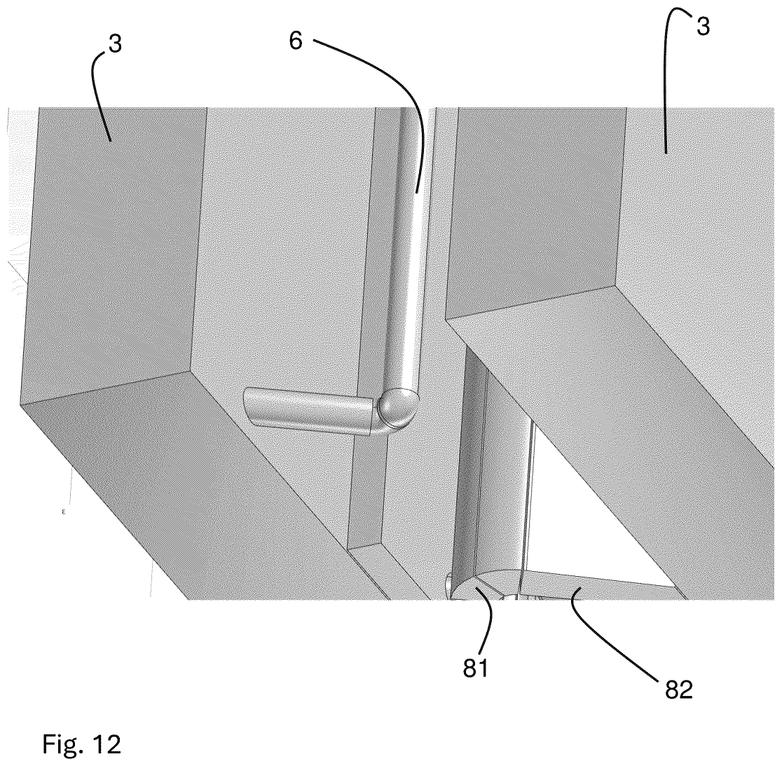

FIG. 11 shows the new conductor path at ‘top’ end with the “shielded” conductor 6 passing through the hole in the small magnets 80′ and 81′ of the flux return. FIG. 12 shows an arrangement of the opposing “unshielded” end of the conductor 6 which is not pasting through a flux return. As shown in FIG. 12, the opposing “unshielded” end of the conductor 6 includes a path which is identical or substantially identical to the “shielded” conductor 6 path.

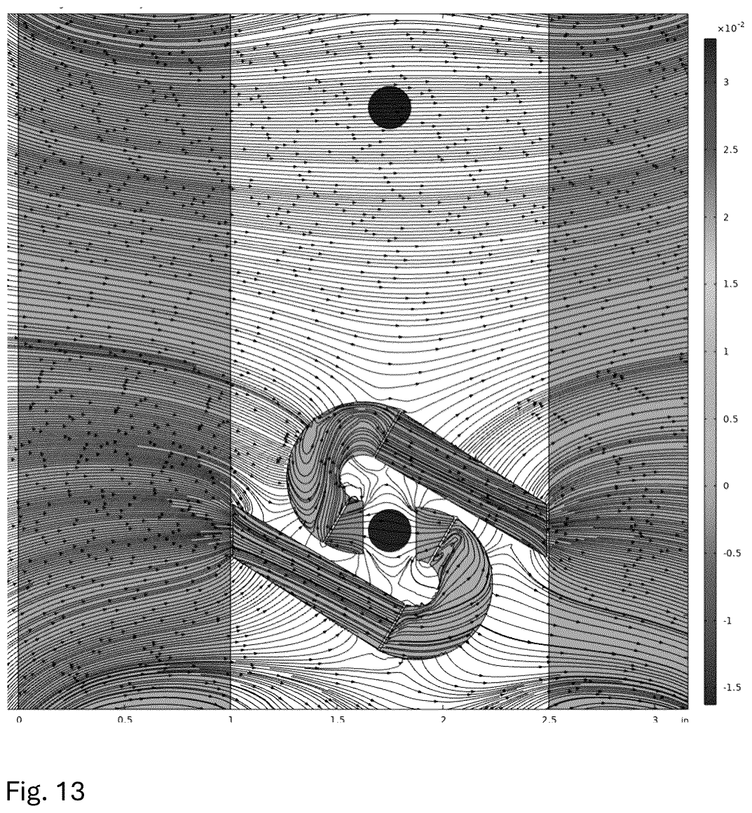

Test 3c: FIG. 13. Iron half circle portions, the rest are magnets, but now the diagonal center flux is perpendicular to the direction of motion. This version has the bent wire exposed through a hole in the magnet as in FIG. 11.
Shielded −659.2 mV
Unshielded 324.8 mV
Over/Under 984 mV

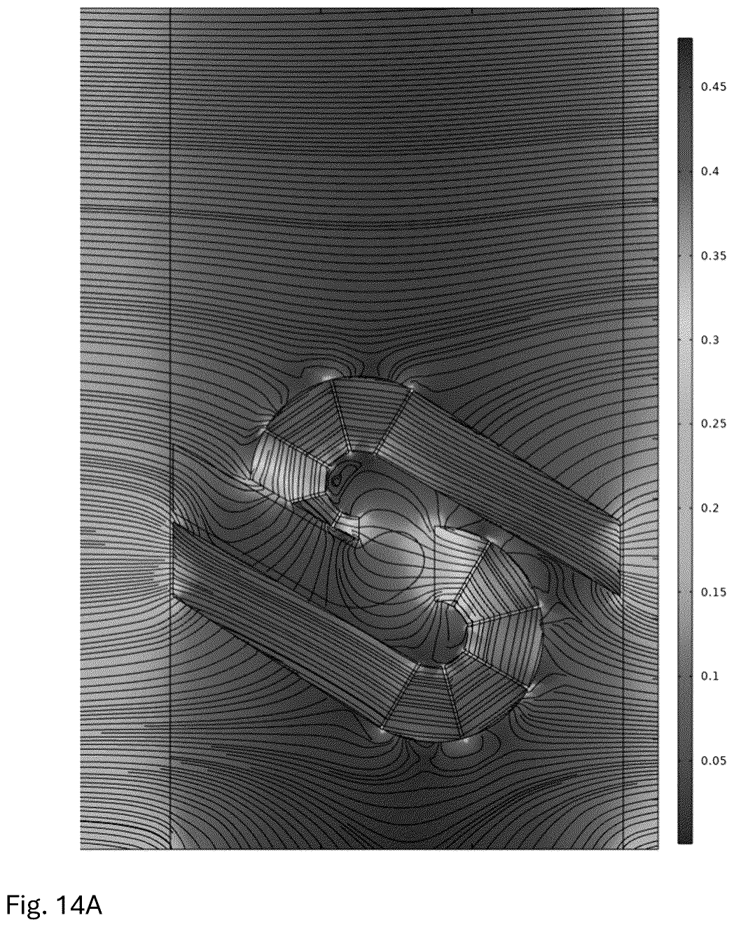

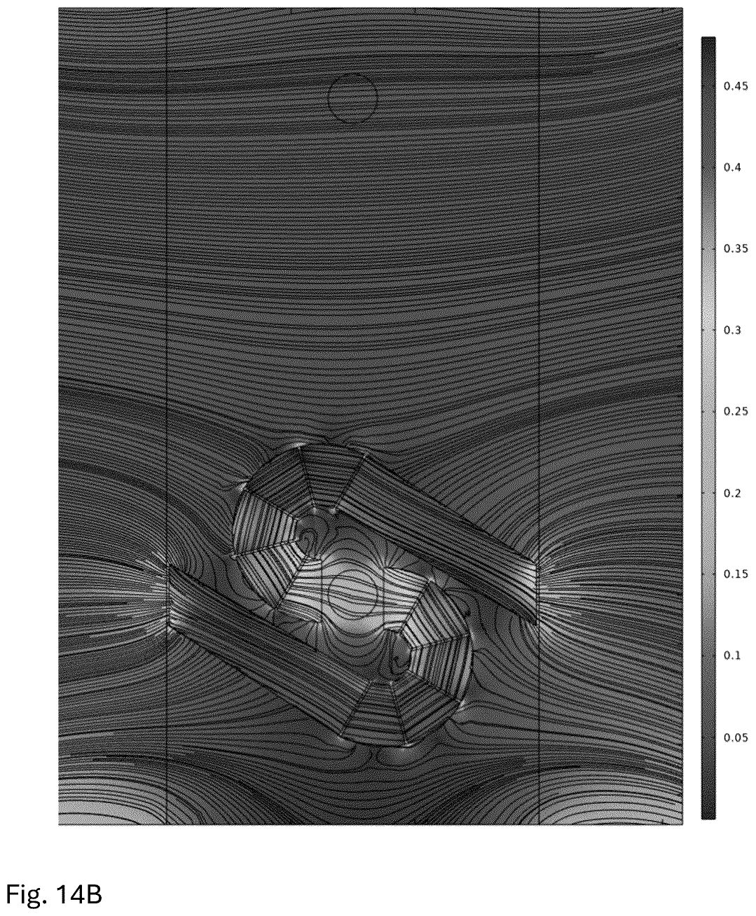

Test 3c2: FIGS. 14A and 14B. An entirety of the sweep of the flux return is now magnets. FIG. 14A shows the hole of the magnets in which the “shielded” conductor 6 extends and FIG. 14B shows the portions of the same structure as FIG. 14A just below the hole of the magnets in which the “shielded” conductor 6 extends.
Shielded −558 mV
Unshielded 326 mV-higher because the large magnets are closer together and continuous magnetic bend.
Over/under 884

Compared to 3b there are multiple changes, the magnetic path of the flux return includes more magnets contributing flux which should improve the output, but it didn't. This may be the saturation limit of the path and there is significant flux leakage into and out of the spiral path. The wire turns left and experiences some of the wrong direction as it exits the magnets which will worsen the output.

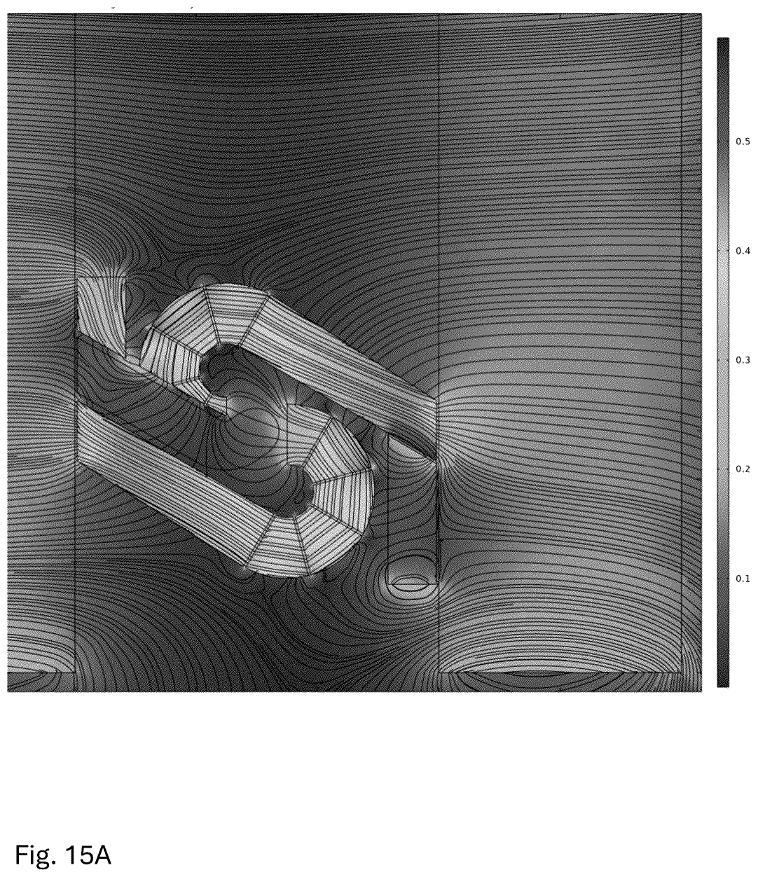

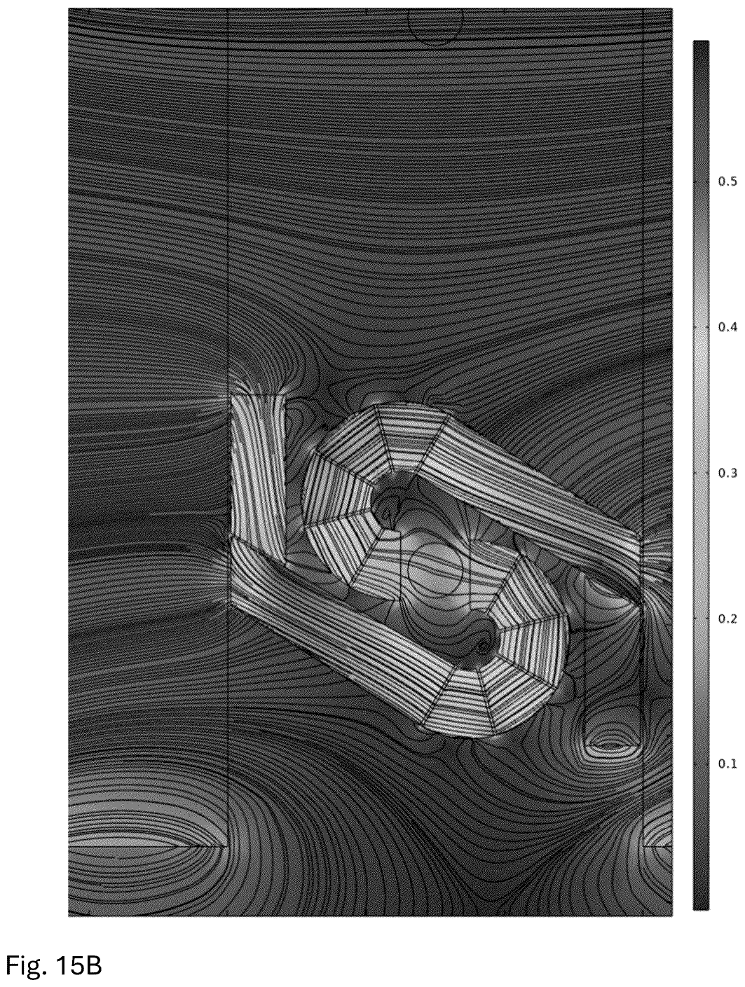

Test 3d: FIGS. 15A and 15B. Similar to the previous test, but 2 more magnets to try and help draw in flux from the large magnet at the beginning with a north down, south up segment and a north left, south right magnet at the right at the end to discourage stray flux leakage in the corners.
Shielded −544 mV
Unshielded 328 mV
Over/Under 882
Surprisingly, although the picture shows clear improvement in the amount of flux being gathered into the path, and much less leaking out at the right sided ‘S’ bend, this did not translate into better performance. We may be up against diminishing return bottleneck to address.

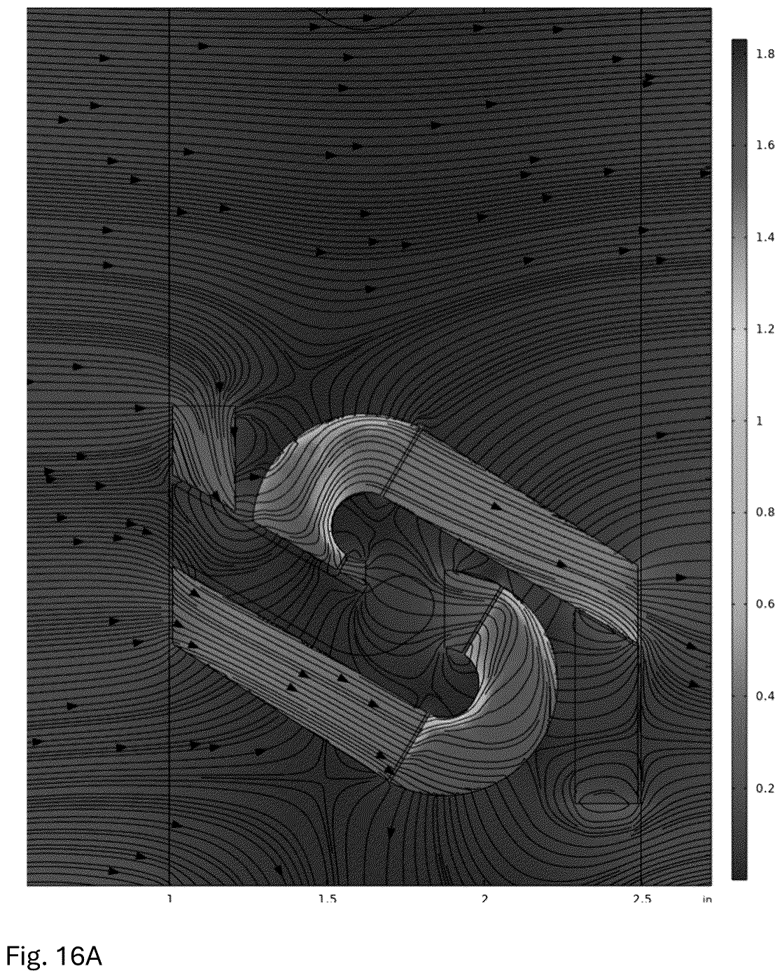

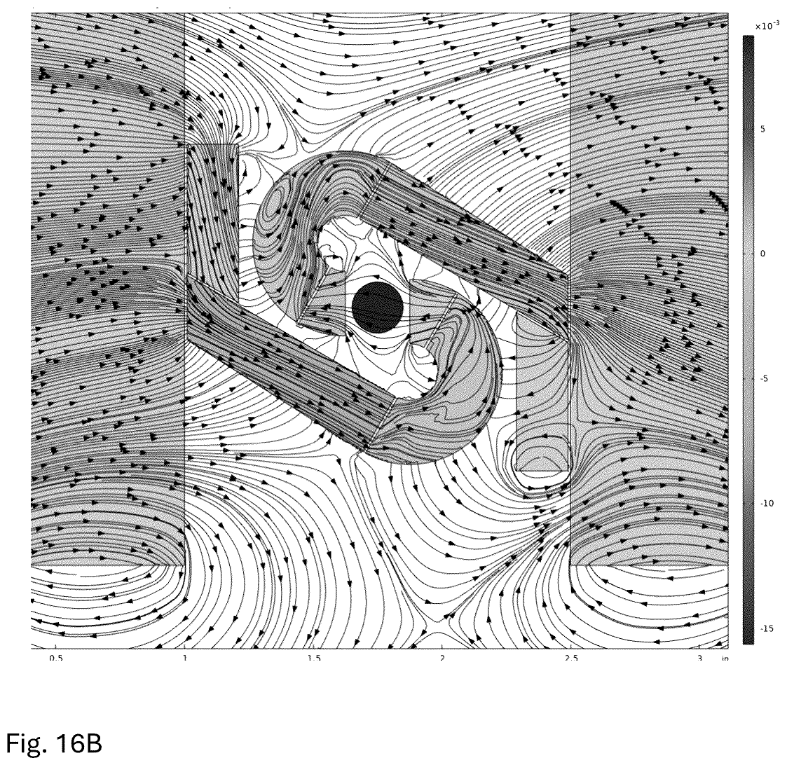

Test 3e: FIGS. 16A and 16B. Same terminal magnets, and went back to iron semi circles/arcs instead of separate magnets.
Unshielded 327 mV
Shielded −483 mV
Over/under 810 mV

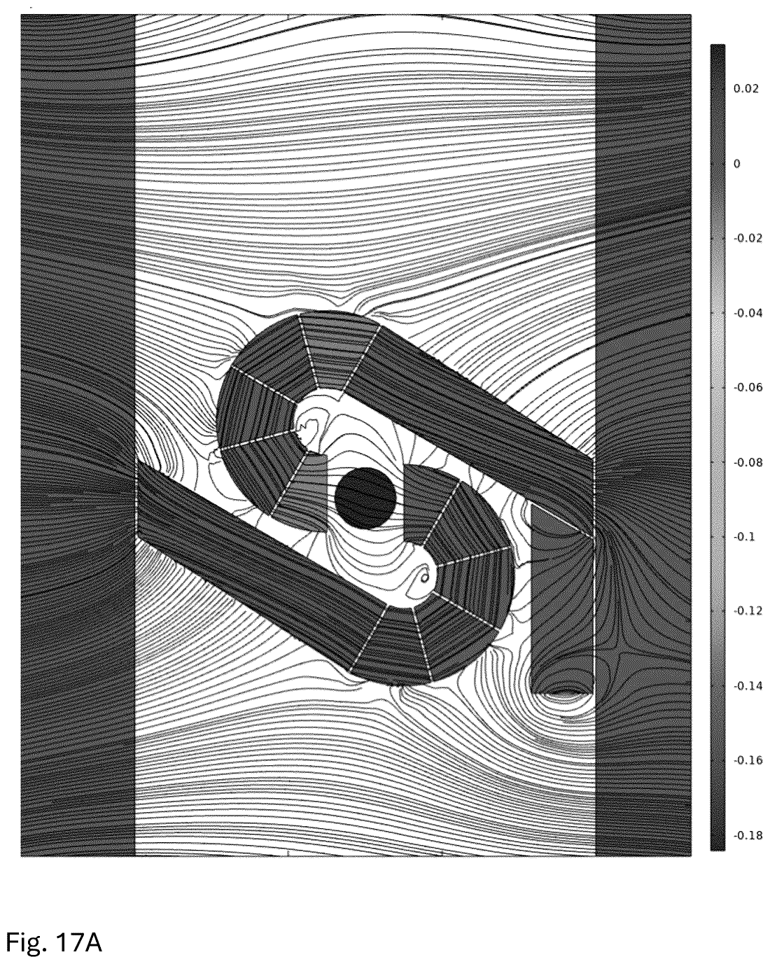

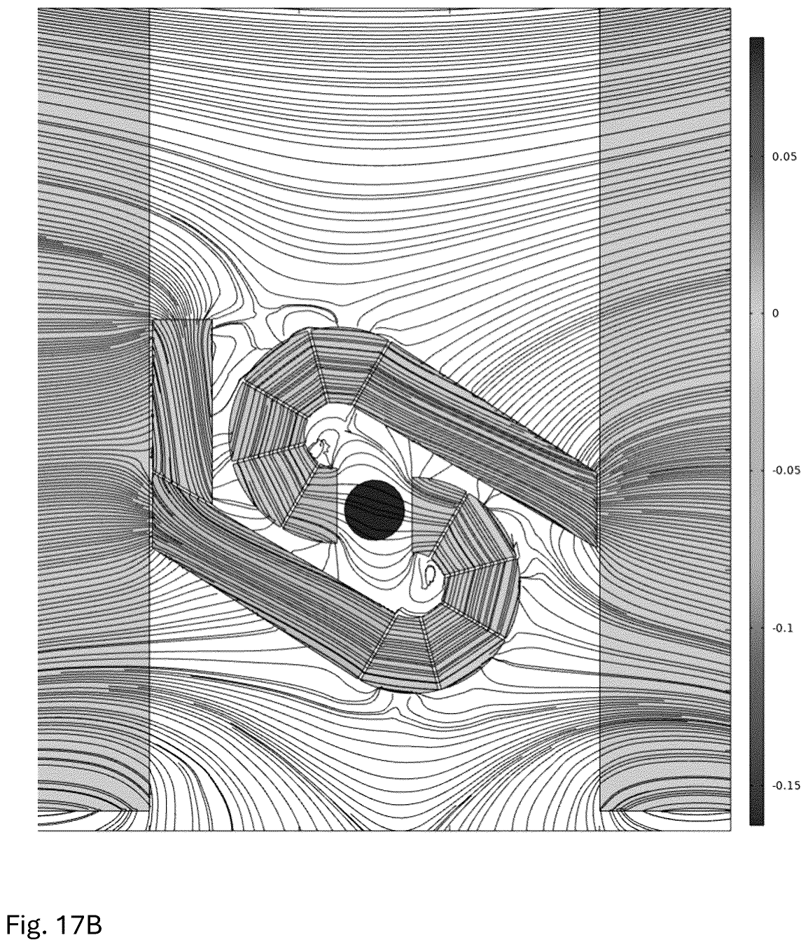

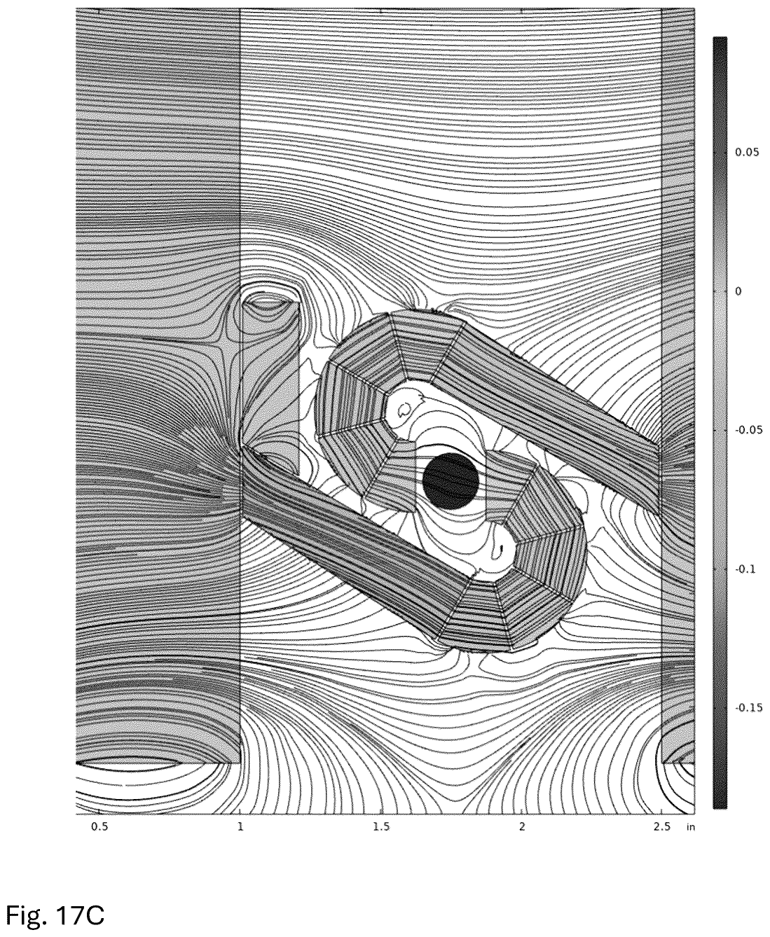

Test 3f-1: FIG. 17A. Now we are looking at one blocking magnet at a time
Shielded −576 mV
Unshielded 325 mV
Over/under 901 mV

Test 3f-2: FIG. 17B. Magnet on left has N pole down.
Shielded −500 mV
Unshielded 324 mV
Over/Under 824 mV

Test 3f-3: FIG. 17C. Magnet on the left has north pole left.
Shielded −574 mV
Unshielded 325 mV
Over/under 899

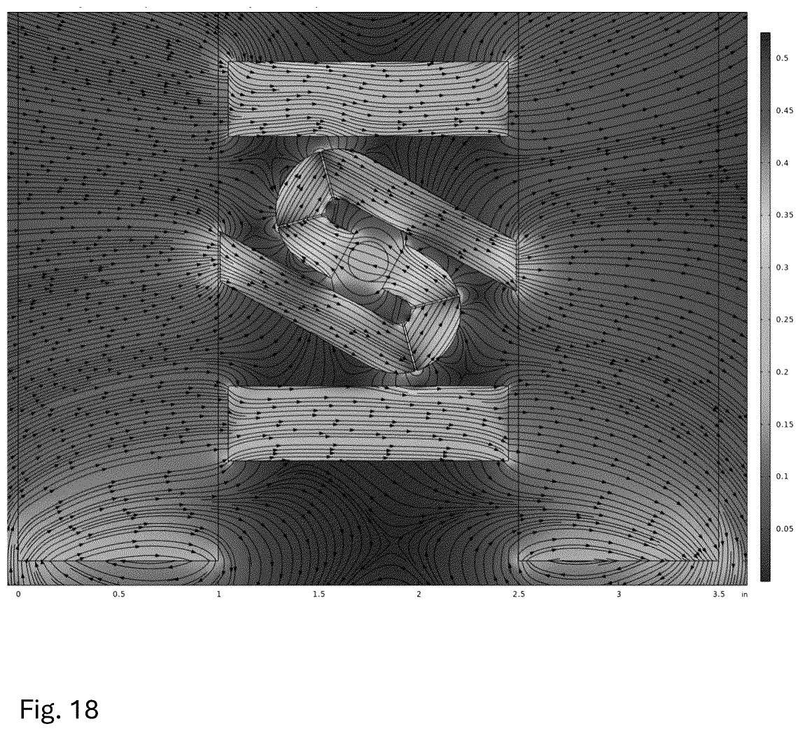

Test 4a: FIG. 18. Adding high permeability iron squares above and below didn't affect the output significantly.
Unshielded is 120 mV
Shielded is −712 mV (Without iron was 721)
Over/under 832
Flux is a little diagonal

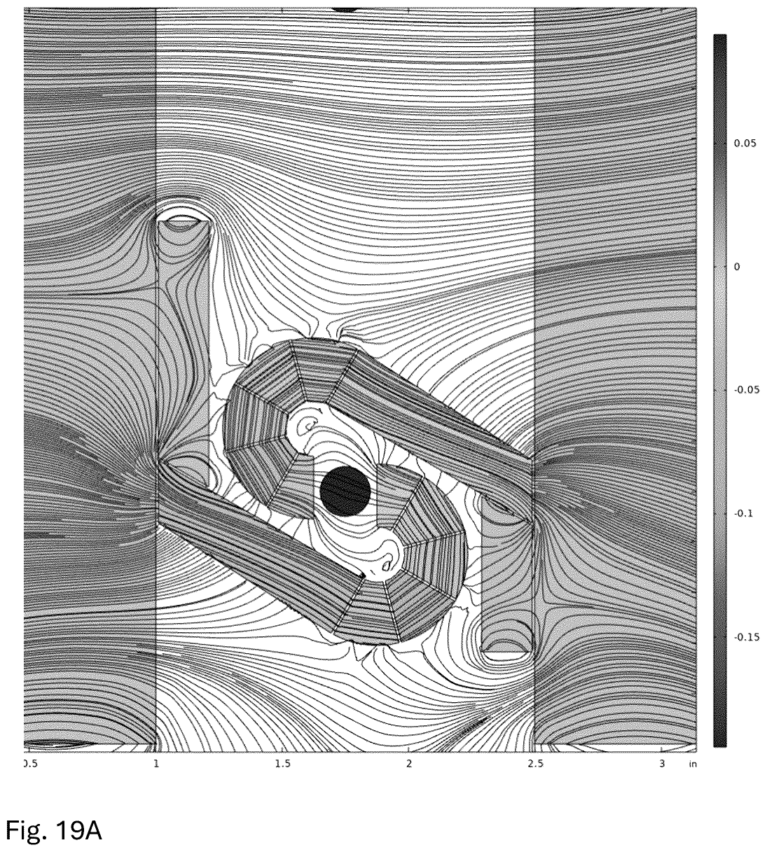

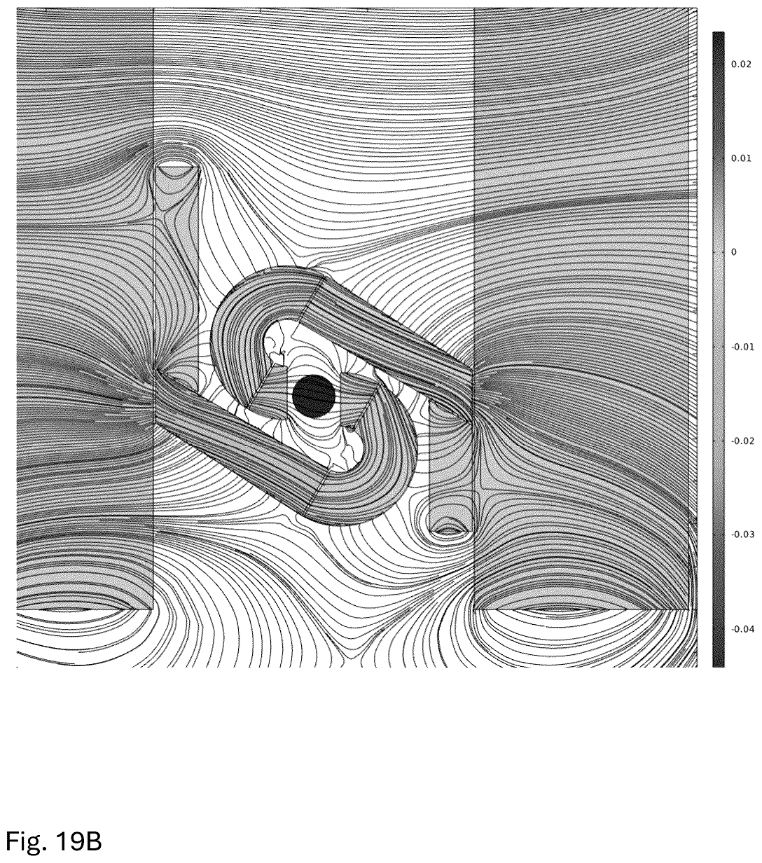

Test 4b: FIG. 19A. Increased length of left side shield magnet as compared to right side shield magnet.
Shielded −601 mV
Unshielded 324 mV
Over/under 925 mV

Test 4c: FIG. 19B. Including single solid semicircular/arc magnets as compared to the multiple small magnets in FIG. 19A.
Unshielded 325 mV
Shielded −724 mV
Over/under 1.049V

The following are a group of less potent permutations.

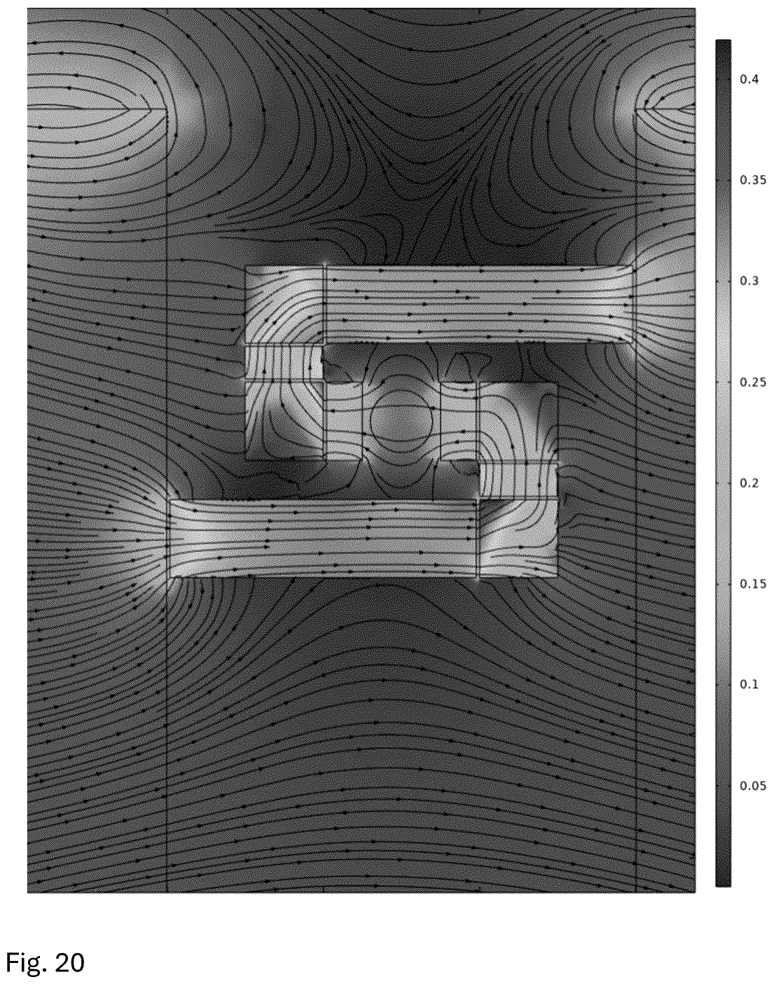

Test 5A: FIG. 20. Iron squares in corners. Magnets everywhere else. More compact. 1 inch spacing between large magnets.
Unshielded 222 mV
Shielded −432 mV
Over/Under 654

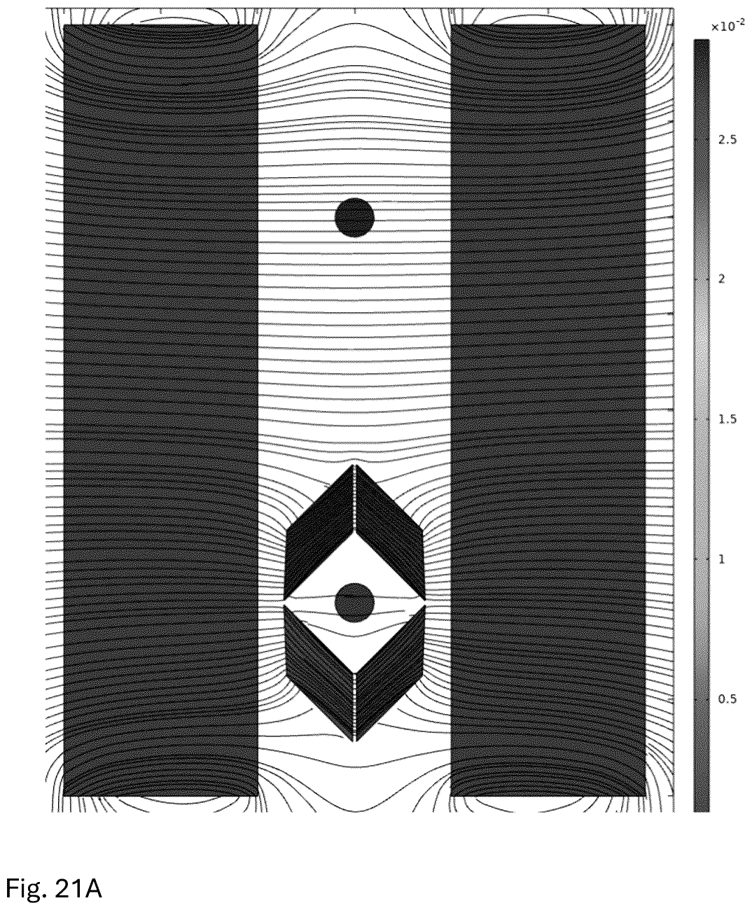

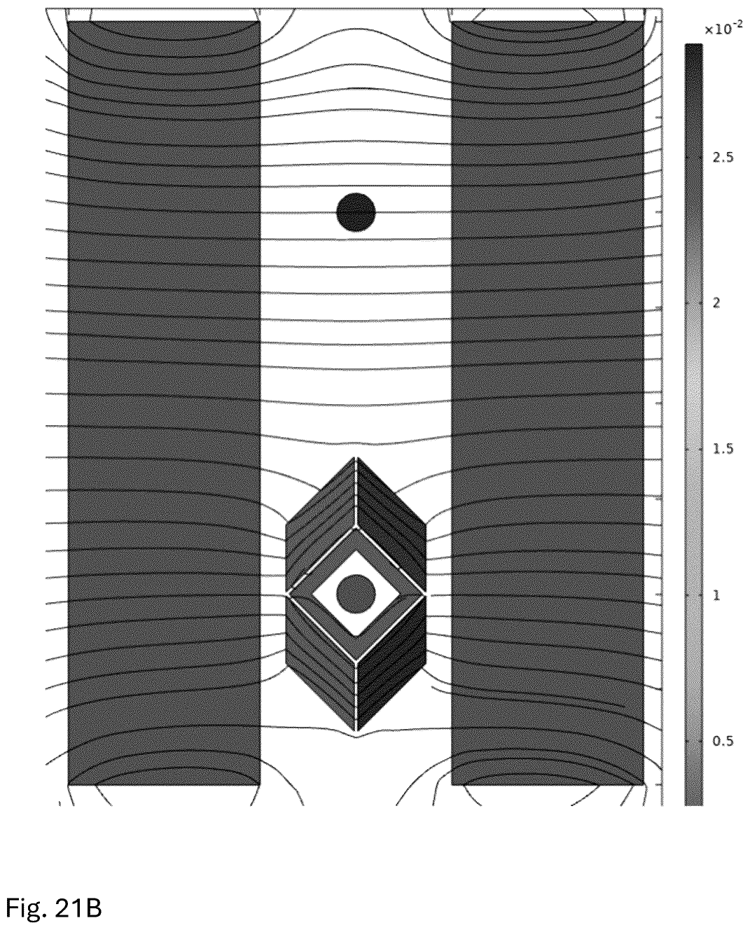

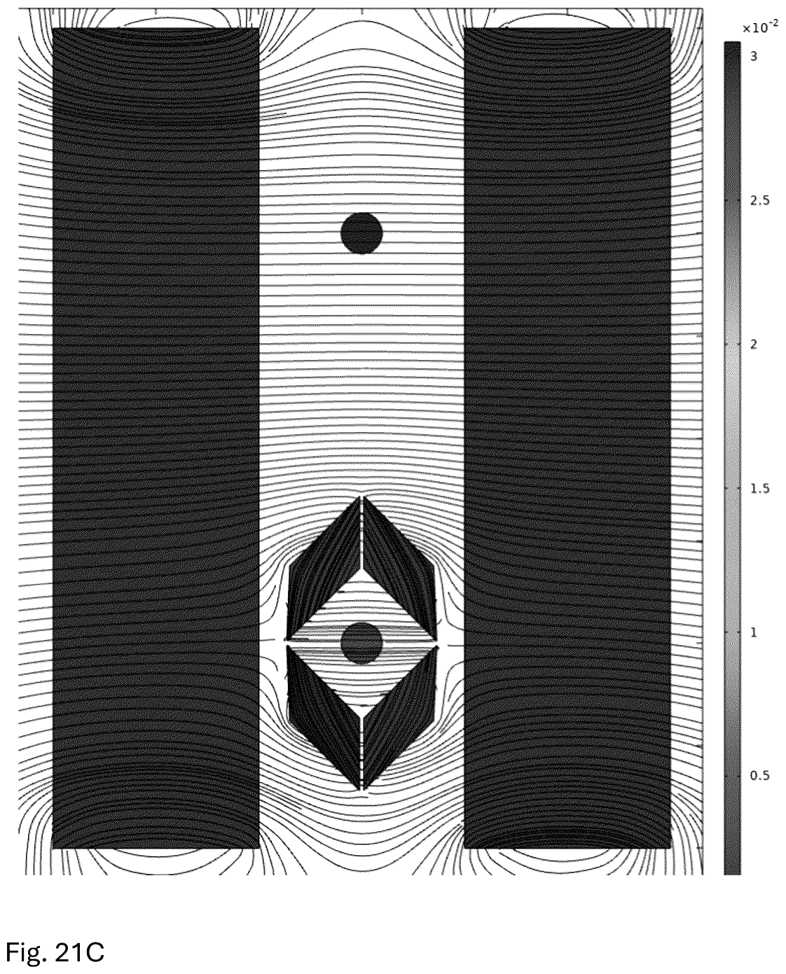

Test 6a: FIG. 21A. Moving small magnets oriented with the flux field of the big magnets but creating a diamond shaped diversion path in between two larger stationary magnets. (North right on large magnets, north small end right on each of the small magnets).
Shows a reduction in voltage from 28 mV to 0.56 mV (50× reduction)

Test 6b: FIG. 21B. Reverse the polarity of the diamond of test 1a. Include four small magnets on 45 deg angles creating a diamond, in between two larger stationary magnets. (North right on large magnets, north left on each of the small magnets so the smaller ones are defining a flux shield pushing the large magnet's flux away from the central conductor.) Both sets of magnets have similar average point surface field strength. The flux inside the diamond travels with the diamond.
Shows a reduction in voltage from 30 mV to 1.97 mV (˜15× reduction)

Test 6c: FIG. 21C. Same diamond shaped small magnets oriented with the flux field of the big magnets creating a diamond shaped diversion path in between two larger stationary magnets. Now with an Iron flux return on inside of small magnets. (North right on large magnets, north on left end on each of the small magnets).
Shows a reduction in voltage from 28 mV to 0.31 mV (90× reduction)

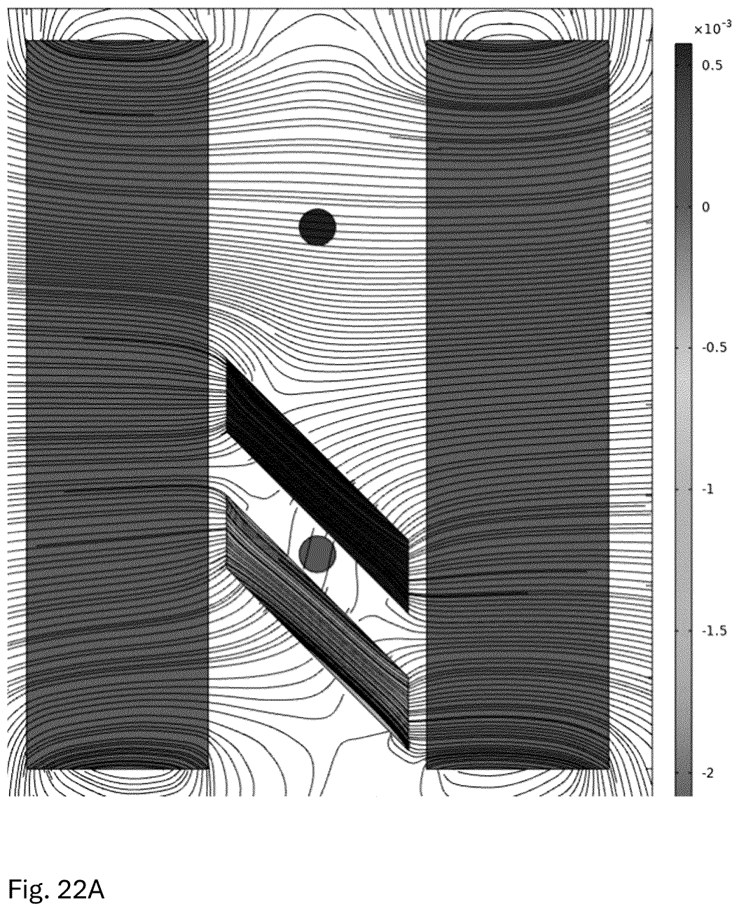

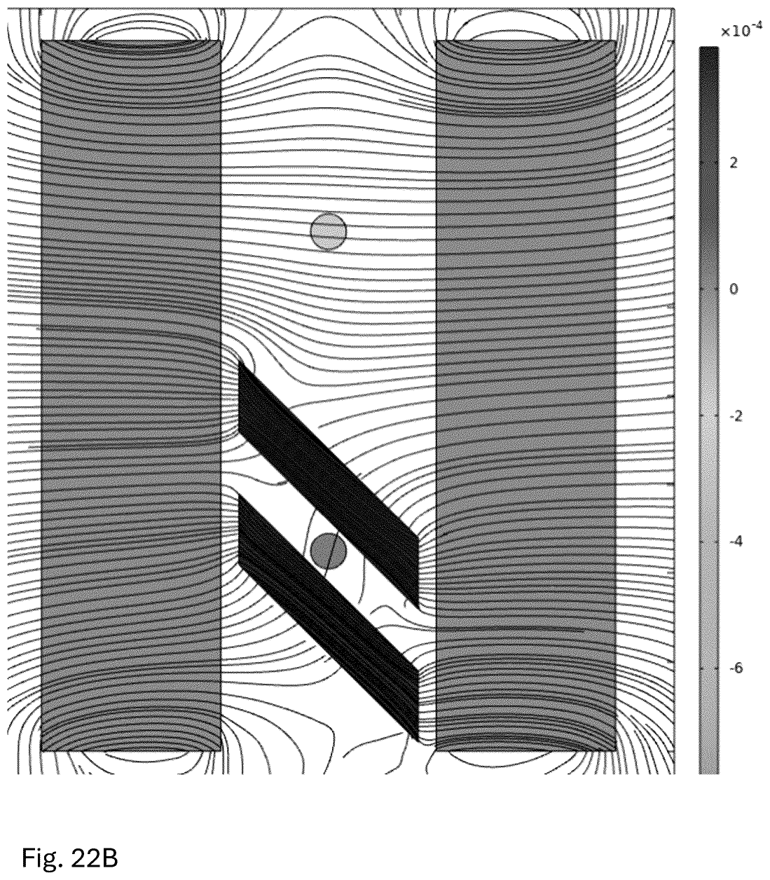

Test 7a: FIG. 22A. Moving small magnets on 45 deg angle, in between two larger stationary magnets. (North right on large magnets, and north down and to the right on a 45 deg angle on the small magnets).
Shows a reduction in voltage from 57 mV to 13 mV (about ¼th)

Test 7b: FIG. 22B. Same as test 2a but polarity of the smaller magnets are reversed. Magnets on 45 deg angle, in between two larger magnets. (North right on large magnets, and north down and to the right on a 45 deg angle on the small magnets). Motion in −Y direction.
Shows a reduction in voltage from 57 mV to 11.9 mV (similar result reduction)
The flux lines are parallel to the direction of motion and seem to have an escalator effect.

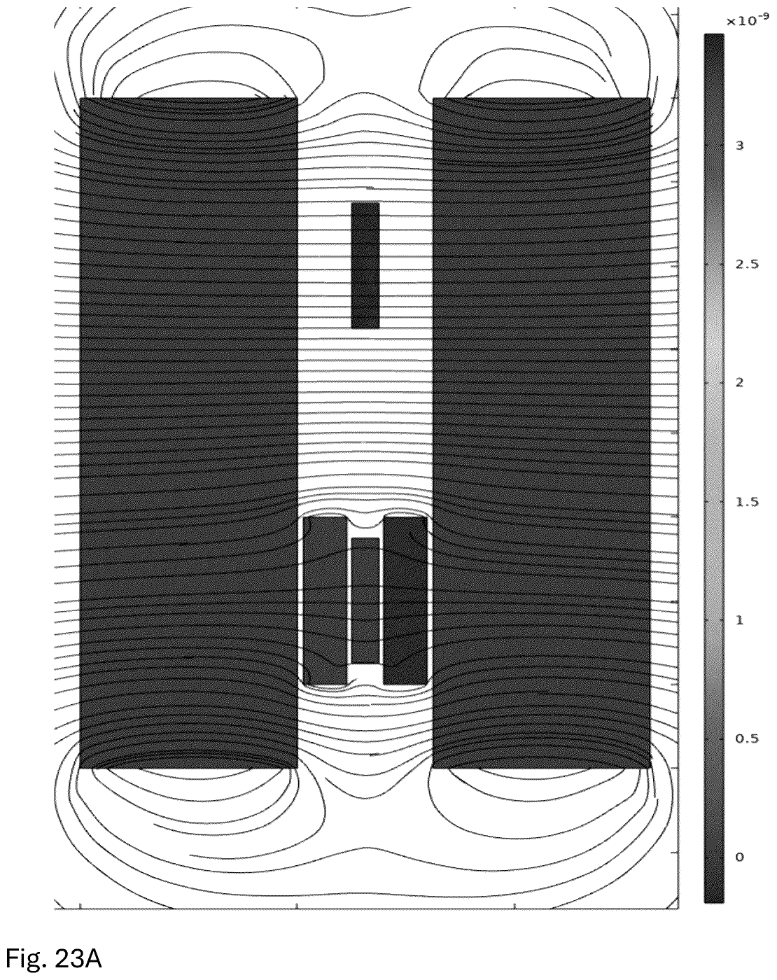

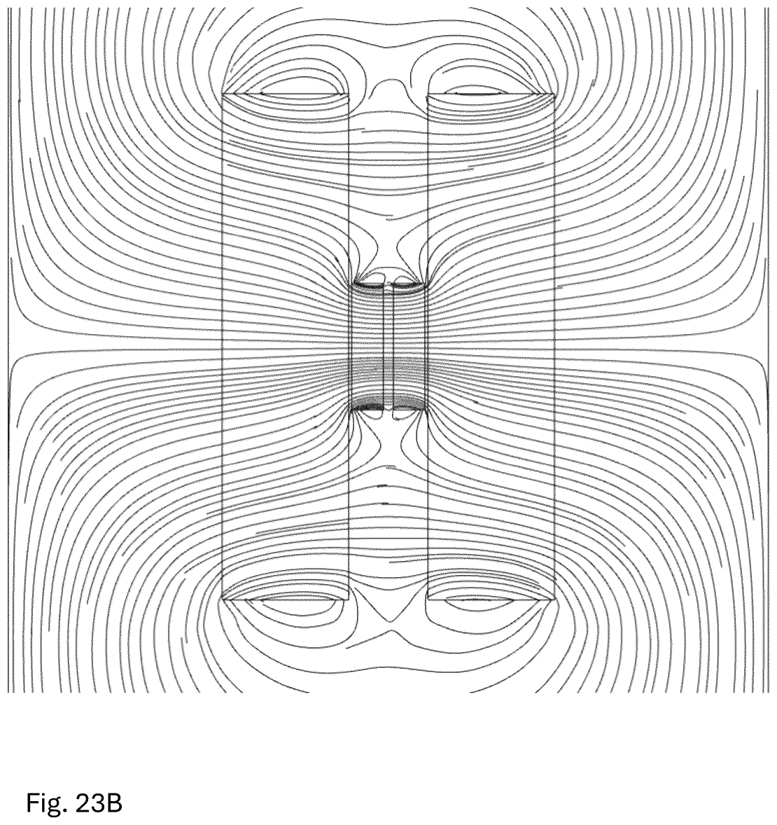

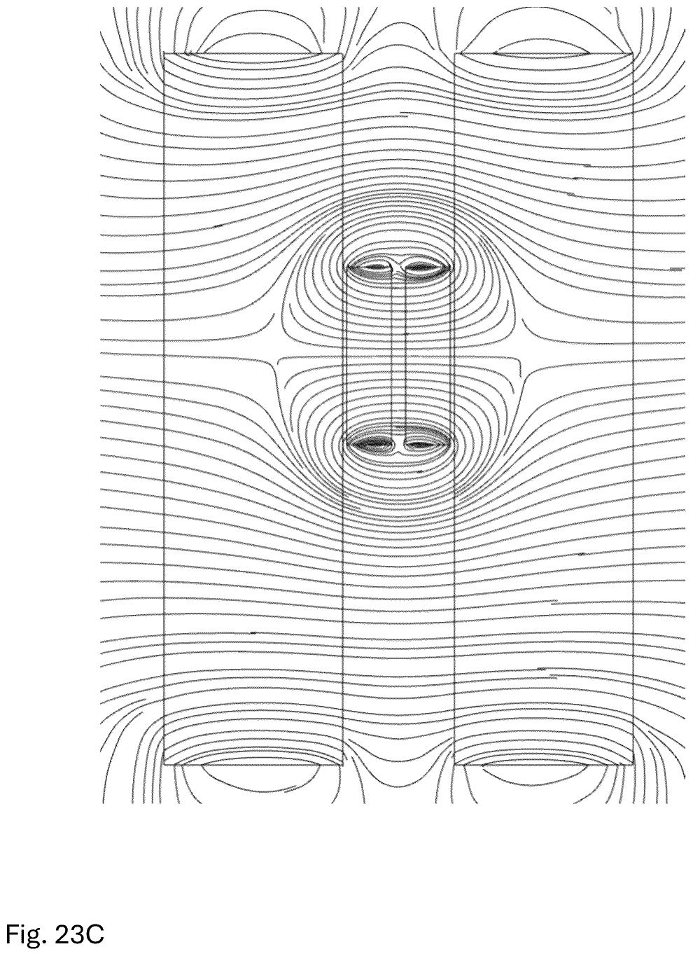

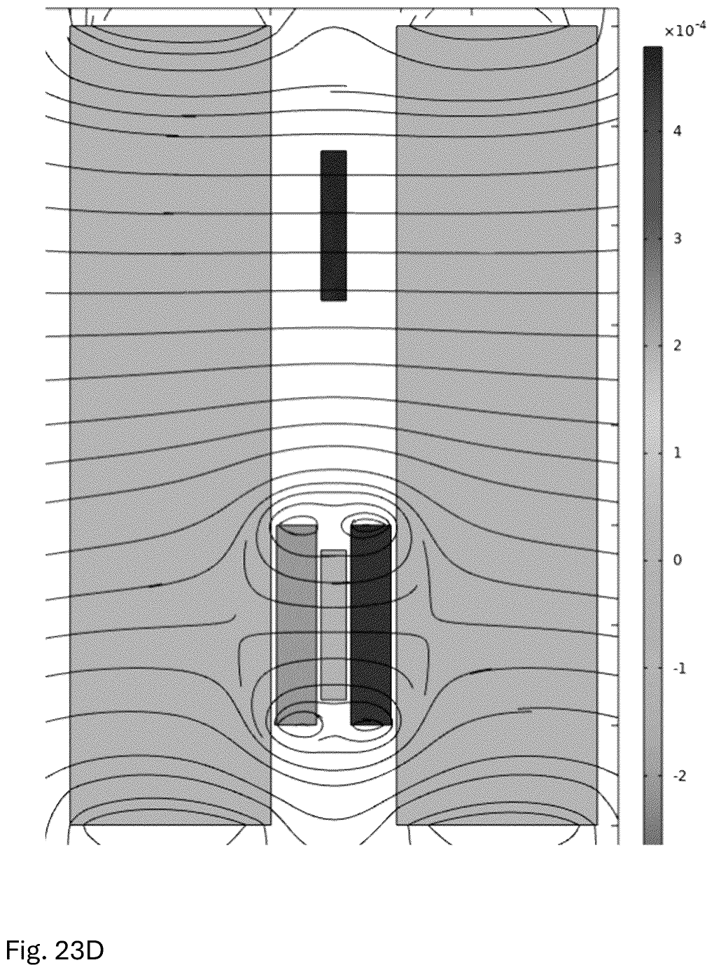

Test 8a: FIGS. 23A and 23B. Parallel small magnets between larger magnets with polarity all in same direction (North to the right).
Seems to shield the conductor, but not perfectly.
The field between the small magnets appears to not travel relative to the small magnets, which was a surprise and requires further investigation, but be paired with the field of the big magnets.
Shows a compression of flux throughout the small magnets that travels with them.
Shows a reduction in voltage by from 0.034V to 0.0028V (greater than 10 fold reduction but low numbers so? accuracy-needs further study)

Test 8b: FIGS. 23C and 23D. Same as 3a but with the small magnets polarized in the opposite direction. Magnets between larger magnets with polarity between groups opposing each other. (North to the right on the large magnets and North to the left on the small ones.). Seems to do better than the same orientation test at shielding.
Creates a field around the small magnets that pushes the field of the larger magnets away.
The small magnet flux traves with the small magnets so it does not impact the conductor.
In the case of making the smaller magnets be 3× field intensity of the big magnets, a reduction in voltage from 0.034V to 0.0008V (42 fold reduction) occurs
Adjusting the magnets to have equal intensity gives a shielded to unshielded ratio of 34 to 2.4+a 14 fold reduction.
This configuration works better as magnet strength of shielding increases, like all others. Weaker magnets do a worse job at reducing induced voltage.

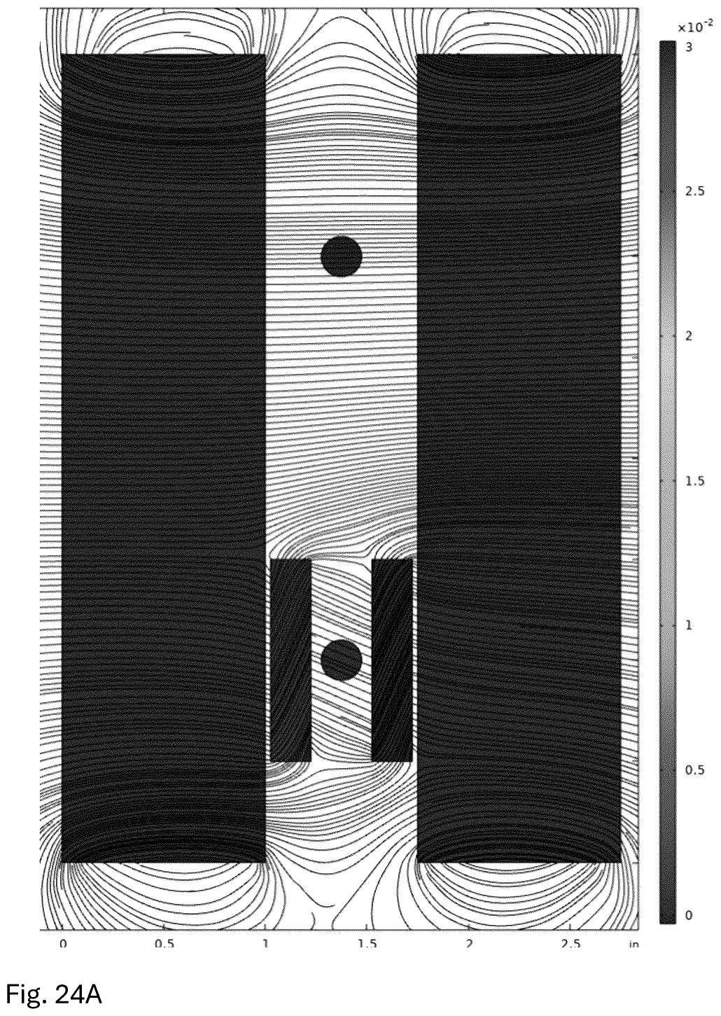

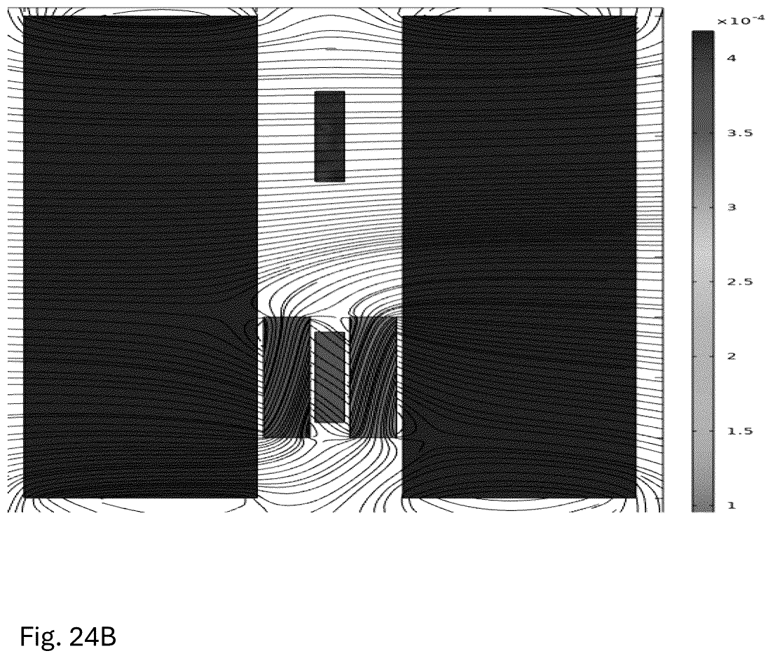

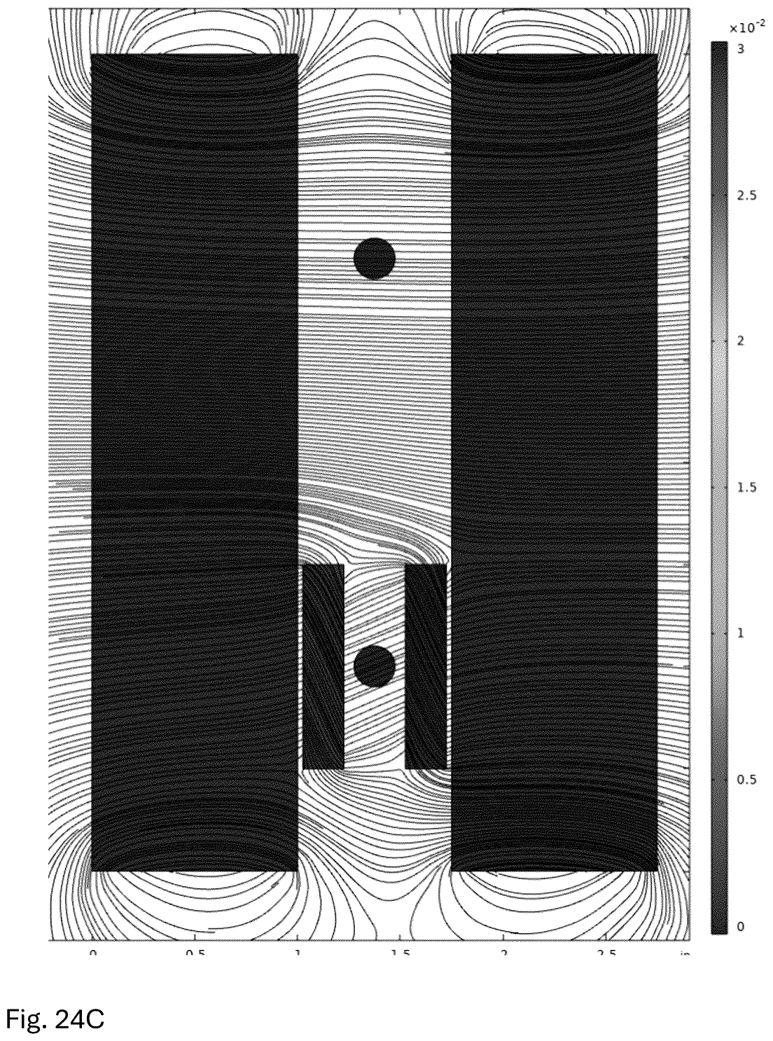

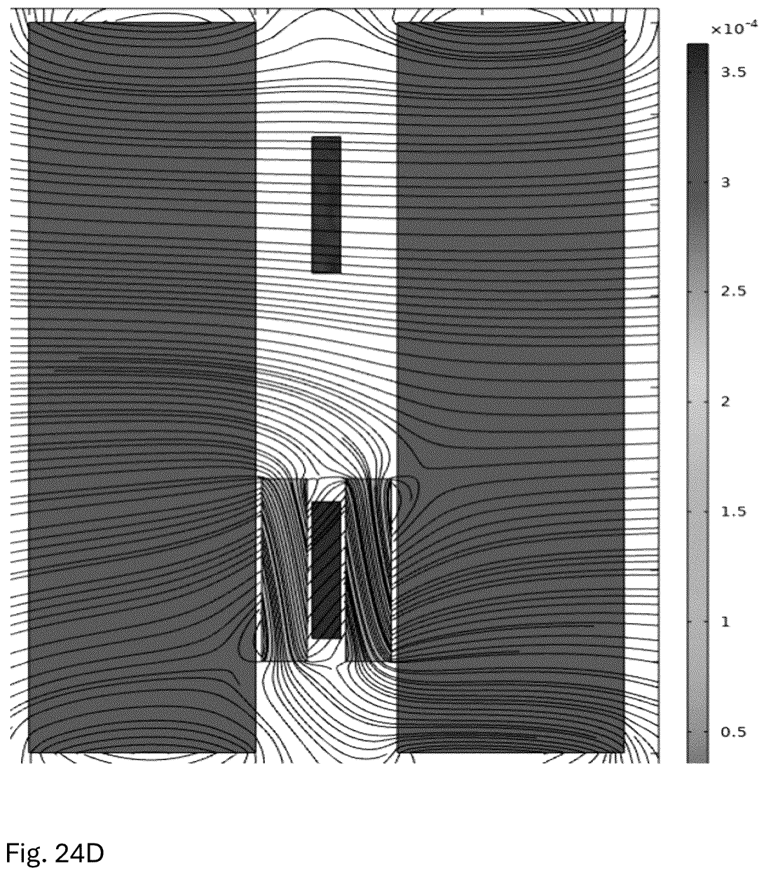

Test 9a: FIG. 24A. Magnets between larger magnets with perpendicular polarity. (North to the right on larger magnets, North up on the small magnets, round conductor)
Voltage Reduced from 30.2 mV to 0.0311 mV (3.11E-5)

Test 9a1: FIG. 24B. Magnets between larger magnets with perpendicular polarity. (North to the right on larger magnets, North up on the small magnets rectangle conductor)
Seems that the shielding tests are doing better whenever the polarity of the two shielding magnets is opposing the force of the larger/main field.
The idea here was to channel the flux from the larger field through the magnets in a physical N/S direction which would guide flux around the copper that is being shielded.
Voltage reduction from 0.0405 to 0.0051 (80 fold change)
It seems that the higher induced voltage in the unshielded copper is due to the increase in flux density on the north side of the small magnets.

Test 10a: FIG. 24C. Magnets between larger magnets with perpendicular polarity. (North to the right on larger magnets, North down on the small magnets, round conductor).
Voltage reduced from 30.2 mV to 0.26 mV.

Test 10b: FIG. 24D. Magnets between larger magnets with perpendicular polarity. (North to the right on larger magnets, North down on the small magnets, square conductor)
Very similar setup to test 4a. Only difference is the small magnets are flipped 180 deg.
Interesting result here, this test does a better job of shielding than test 3a. But also creates a small negative voltage in the shielded wire. It was discovered that the leading edge being south would function better.
Voltage reduced from 35.7 mV to 0.27 mV (WOW 132 X)
Would work better w more airspace between the small magnets.

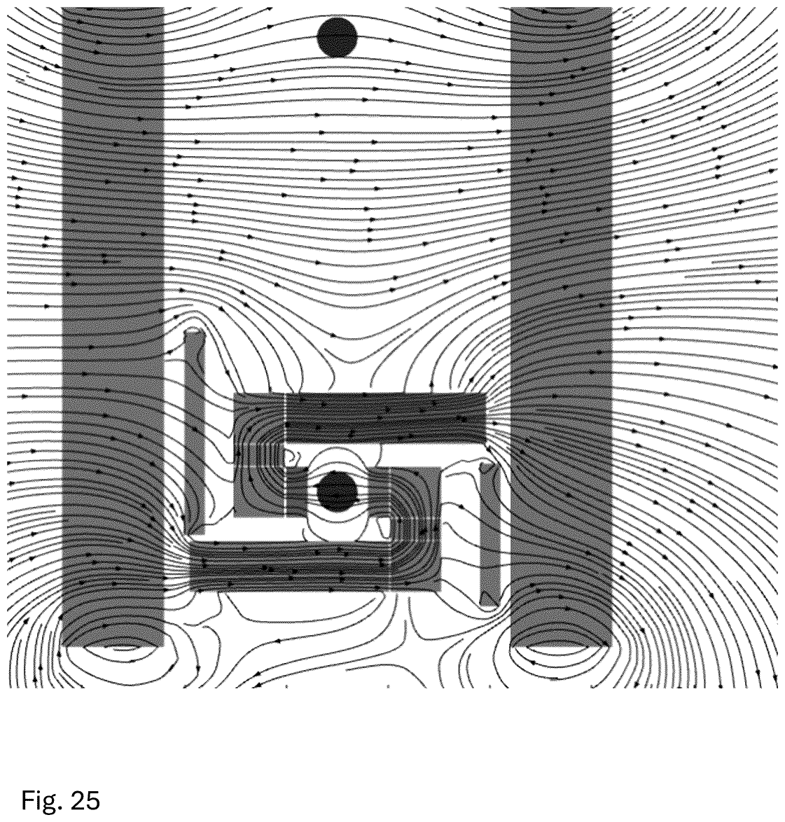

### Test 11: FIG. 25.

Unshielded 14.033 mV
Shielded −56.963 mV

As seen in the limited sampling of example embodiments discussed above, while different arrangements have different efficacies, correctly designed and applied active shielding can be so effective, it not only solves the issue, but goes on to add extra voltage into the system. The above methods can be combined.

Care has to be taken to prevent the small magnets of the active shield (e.g., the smaller magnets and/or magnetically permeable/ferromagnetic material defining a flux return) and the larger flux field of the stator magnets from interacting negatively with each other. I.e., the active shield might be effective enough to prevent reverse flux voltage induction in the connectors, but if its reverse flux interferes with the stator function, output and efficiency drop. Further, a shield that operates in a test stand might function less well in the complex fields inside the generator/motor.

Therefore a next step is to make a traditional, non-active magnetic shield such as a multilayer sheet steel or sheet iron or sheet iron/nickel alloy if that becomes necessary for a specific application or example embodiment.

Next will be discussed a series of other options for solving the flux return/rotor connector EMF issue according to additional example embodiments of the present invention.

### 1. “Flux Bearing”

At the point the wires/connectors transect the flux return, a series of circumferentially separate but axially paired individual trapezoidal magnets in purple bridge the lateral disk yoke with the inner flux return yoke. The concept is to have a series of air gaps and magnets panning the circumference so that the part of the field in the yokes is stationary but it is paired with the rotating fields in the magnets so the wires traveling in the airgaps between the magnets experiences less flux. Because the magnets are distinct from their circumferentially adjacent magnets, a rotating section is created.

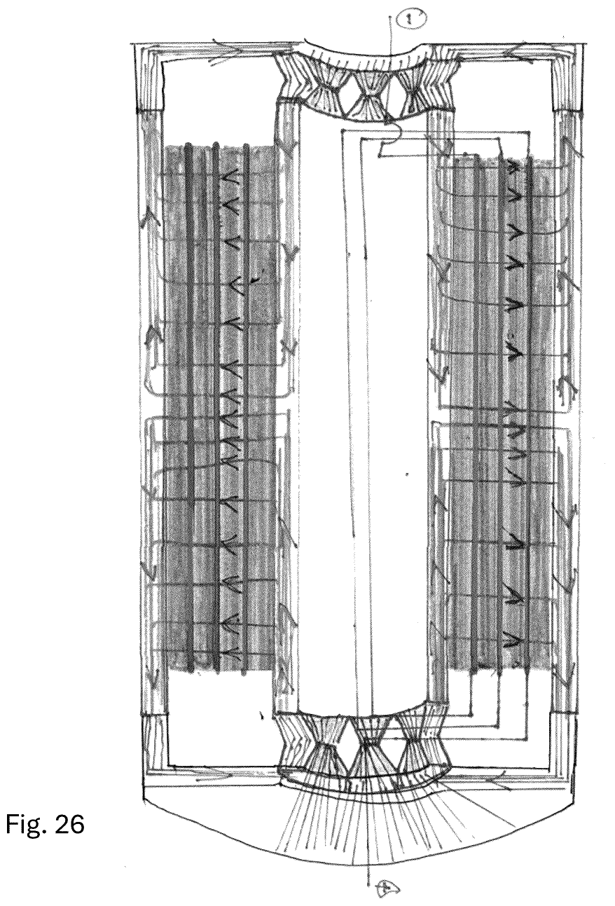

FIG. 26: The individual magnets are paired laterally and in this instance attached to the inner yoke in distinct circumferential locations. This is only partially effective as the stationary field tends to pass from magnet to magnet laterally as they rotate through it. One or more magnet pairs can be reversed which can make it more effective. As can changing the north south axis to be circumferential or radial to perturb the paradox field. There is utility in making a Halbach array. Further, adding bismuth or pyrolytic carbon, for example, to the gaps can help.

### 2. “Flux Invisibility Cloak”

Here, the electrical connections are sandwiched between paired magnets that rotate with the connectors and the device and have polarity in the opposite direction that the flux is traveling. The inner field between the individual magnets rotates with the electrical connectors. The outer side individual magnet flux repels the flux return around the wire. This is similar to test 8b above.

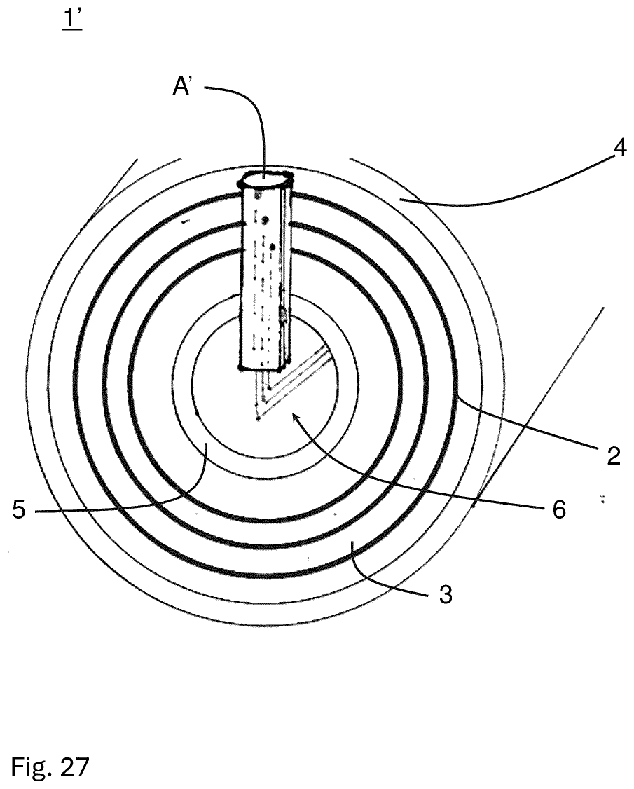

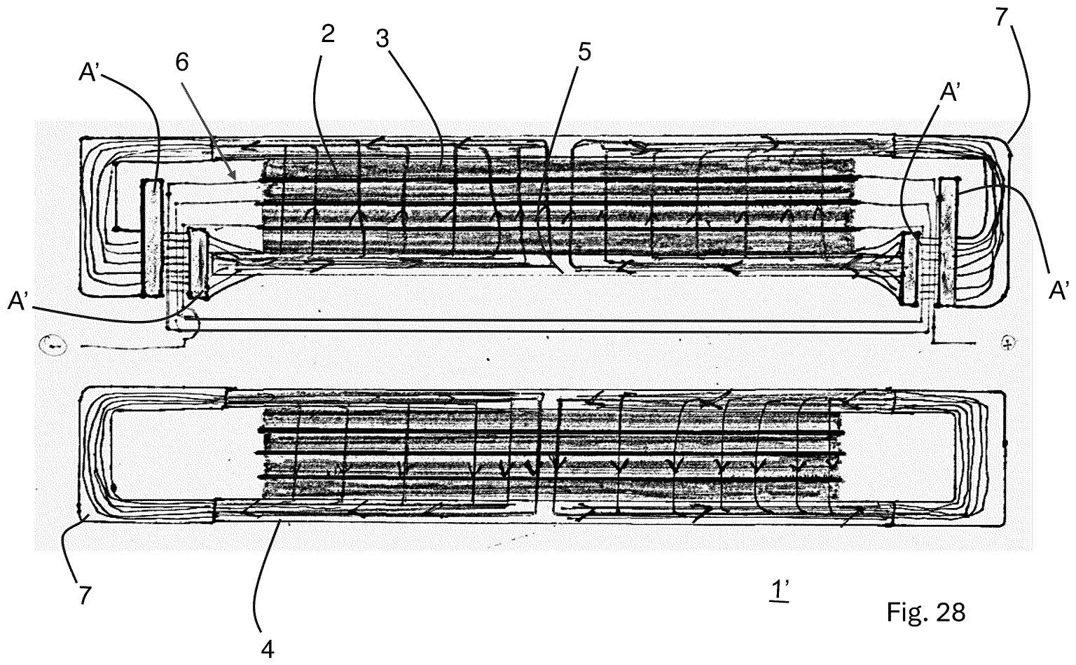

As shown in FIGS. 27 and 28, individual magnets (A′) sandwich the rotor's electrical connectors 6 in a field that rotates with the connectors.

Here, the electrical connections 6 are sandwiched between two individual paired magnets (A′) that rotate with the connectors 6 and the device 1′, the two individual paired magnets (A′) preferably being provided at a single circumferential portion of the device 1′. The inner field between the individual magnets A′ rotates with the electrical connectors. The outer side individual magnet flux pairs with the return flux. With this arrangement, the wire/connectors 6 do not transect the flux and do not experience EMF induction.

Alternatively, the shielding magnets (A′) could be put in with reversed polarity. The shielding magnet (A′) flux field would not pair with stator magnets' 3 return flux. In this orientation the shielding magnets' (A′) flux would repel the stators' 3 return flux to course around the rotor 2 connectors.

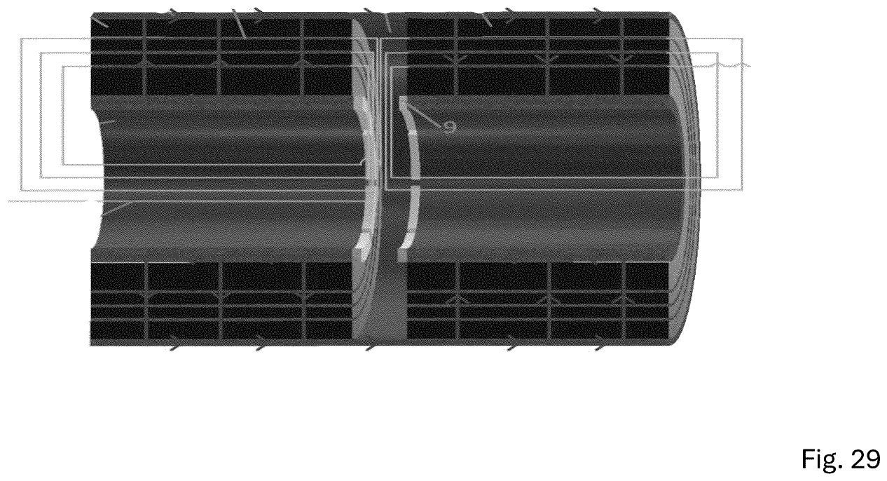

FIG. 29 shows an example embodiment which contains essentially 2 drum generators with opposite polarity stators which are joined in a common yoke such that each stator acts as part of the other stator's return flux.

In this example embodiment of FIG. 29, two cylindrical stacks of rotor/magnet layers are depicted as red and grey layers. The red is the conductive rotor layers and the black is cylindrical magnets with radial orientation. (The solutions for connecting the rotors also apply to permutations described in related application 63/659,440 (hereby incorporated herein by reference) wherein the conductive layers and magnet layers are combined into single layers that are stacked with other such layers concentrically, but with electrical insulation between the layers. As well, these solutions apply to the structures described in all related generator/motor applications.) The cylindrical concentrically nested rotor/magnet ‘stacks’ described in this example embodiment are adjacent in the same external flux return cylindrical yoke. In this embodiment the stack on the left of FIG. 29 has the north side of the magnets facing outward, and in the right side stack, the north sides are facing centrally. The stacks could be the other way around as long as the polarity is reversed between the stacks.

There are also example embodiments with more than 2 stacks. In this 2 stack example, the EMF in the rotors is either directed in opposite directions because the rotor flux is directed in opposite radial directions. Depending on the direction of spin, the stacks would produce emf that pushes in opposite directions-laterally or medially depending on the direction of spin. Each stack is part of the flux return for the other stack. Each stack contributes extra flux to the other.

The inner yoke flux return is separated into 2 adjacent cylinders. In the space between the medial ends of the 2 inner flux return cylinders 2 rings of permanent magnets that are affixed to their respective tubes. These individual magnets (A′) in FIG. 28 are oriented such that the flux on their lateral surfaces pairs with the stationary field in the inner yoke. Opposite poles of the purple magnets face each other across a gap through which the electrical connectors pass. The gap can be between one lateral pair of purple magnets. The other lateral magnet pairs can touch longitudinally or be one or more magnets stacked north to south. The wires could pass through a hole in a magnet. The field in this place the wires pass rotate with the machine. The fields in the laterally paired magnets (A′) rotate with the machine. A side benefit is that the individual magnets contribute more flux to the circuit.

### 4 “Crown Inner Yoke”

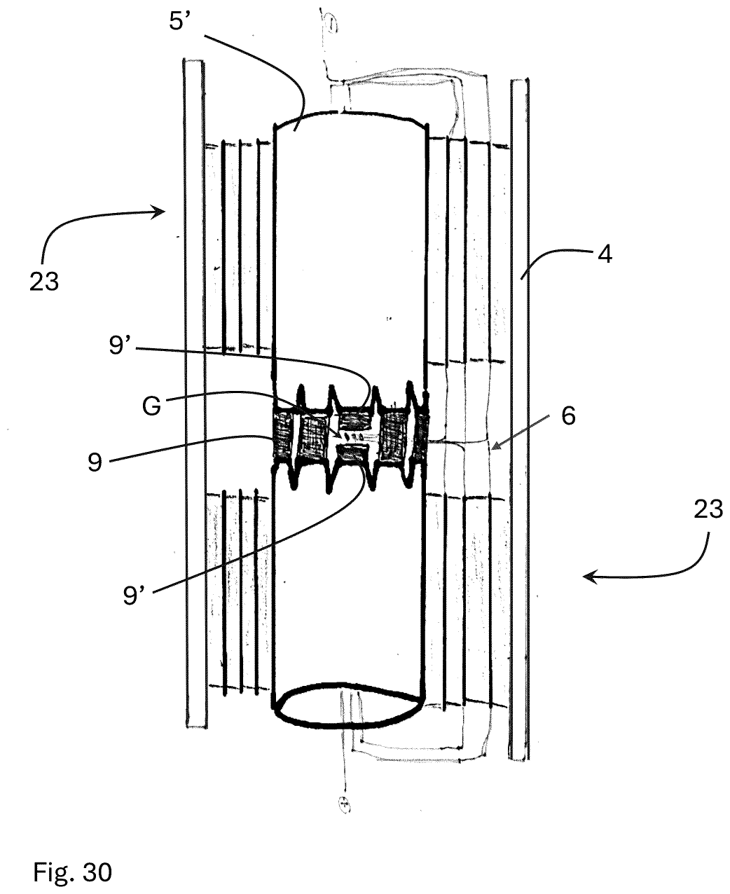

FIG. 30. An alternate embodiment showing the inner yoke flux returns slotted medially to divide the flux. The crown inner yoke could be included without magnets or with one reversed. FIG. 30 shows an alternate example embodiment showing the inner yoke 5′ flux returns slotted medially at axial ends to divide the flux. The space between the inner yokes 5′ is bridged by individual magnets 9 oriented such that they pair with the flux from the cylindrical yoke sections literally and creating discrete flux bridges between them. In this case, the wires come through a gap (G) between two fractional magnets 9′. Having them travel in the spaces between lateral magnets or through holes in the magnets is considered in all of these solutions.

### 5. “Rotating Radial End Caps”

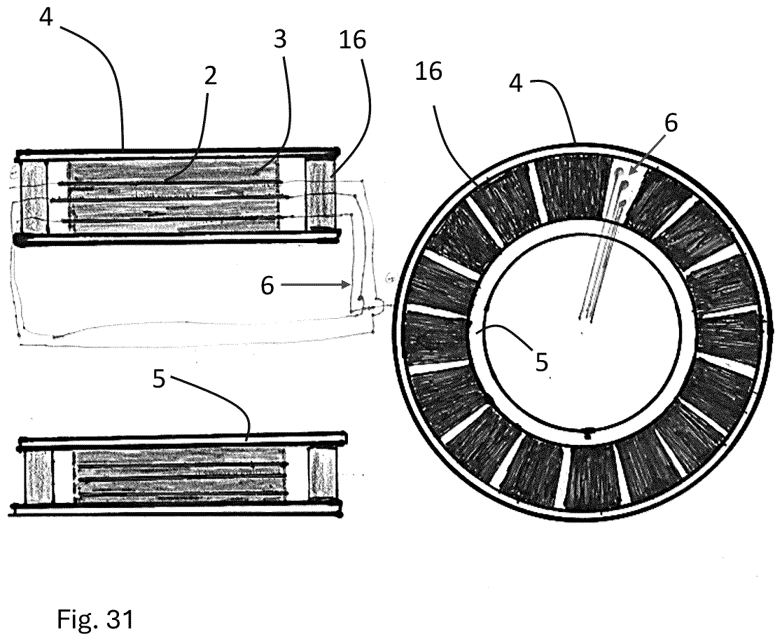

FIG. 31 shows a side view cross section and axial end on views of an alternative example embodiment of the present invention. This example embodiment makes the return flux passing through the end caps rotate by utilizing radial magnets 16 that are discrete assemblies and connect the inner yoke 5 and outer yoke 4.

In this example embodiment, instead of monolithic disks as end cap yokes, wedge shaped individual magnets 16 are preferably used, for example. On the periphery, the magnets 16 pair with the flux in the outer yoke 4 and in the center they pair with the cylindrical inner yoke 5 to provide a flux return path that rotates at the axial end. As long as the radial magnets 16 supply at least as much flux as the cylindrical yokes 4 and 5 deliver, the wires pass through the end caps relatively unmolested by a paradox field.

An enhancement would be to include parametric shielding with materials such as, for example, bismuth and/or pyrolytic carbon around the wire 6 at the level at which it crosses the flux or perhaps some paired magnet around the wire.

### 6. ‘Flux Plugs’

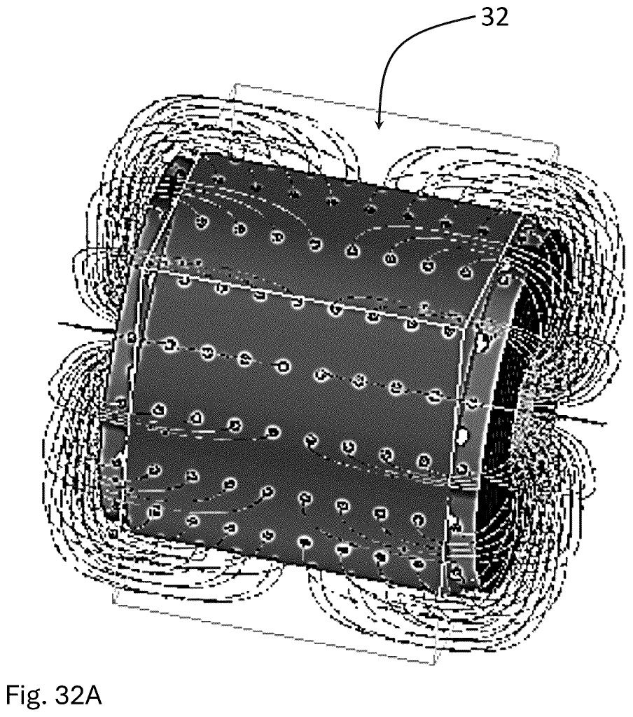

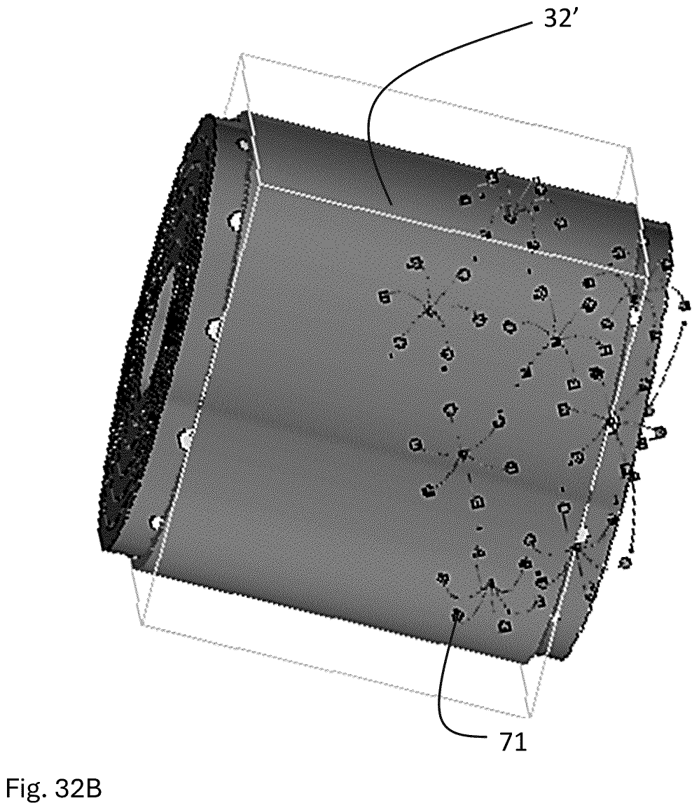

FIGS. 32A and 32B show additional example embodiments of rotor-stator stacks according to an example embodiment of the present invention. FIG. 8a shows a return flux field that forms around the rotor-stator stack 32. Traditionally, the generator is encased in a yoke that contains this return flux and generally mimics its path. In FIG. 8b, holes 71 have been drilled or otherwise formed radially through the cylindrical layers of a rotor-stator stack 32 to provide a series of alternate internal flux return paths having, for example, starburst shapes. The holes 71 would not be not confined to one section of the rotor-stator stack 32 as is shown in FIG. 8b for simplicity. The holes 71 can be filled with plugs made of a material of suitable permeability and saturation to pull the return flux away from the axial ends such as iron, for example. The material of suitable permeability can also be cylindrical magnets with reverse polarity from the stator magnets. They need to be electrically isolated from the rotors. Configurations such as this move the return flux away from the axial ends of the rotors 2 where the connectors pass. The plugs can be layered with more permeable material toward the center to reduce lateral flux interactions.

Minimally effective additional solutions include alternative wire routes including drilling the wire path down through the magnets near the edge instead of routing the wires at the space next to the rotors' ends, traditional shielding of the wires/connectors against the flux field, and using diametric, axial or otherwise magnetized stacked ring or cylinder magnets as passive shielding around the wire would largely only be sufficient if the wire was oriented parallel to the flux field. When the wire's course cuts the field lines, shielding around the wire is not effective because the flux line would have to break to allow the wire to pass through it without creating EMF, which is not realistic. However passive shielding can help isolate the active shielding field from the stator return flux. Further, the plugs or wires can have a paramagnetic surround.

The following are some additional example embodiments of flux shield permutations of the present invention.

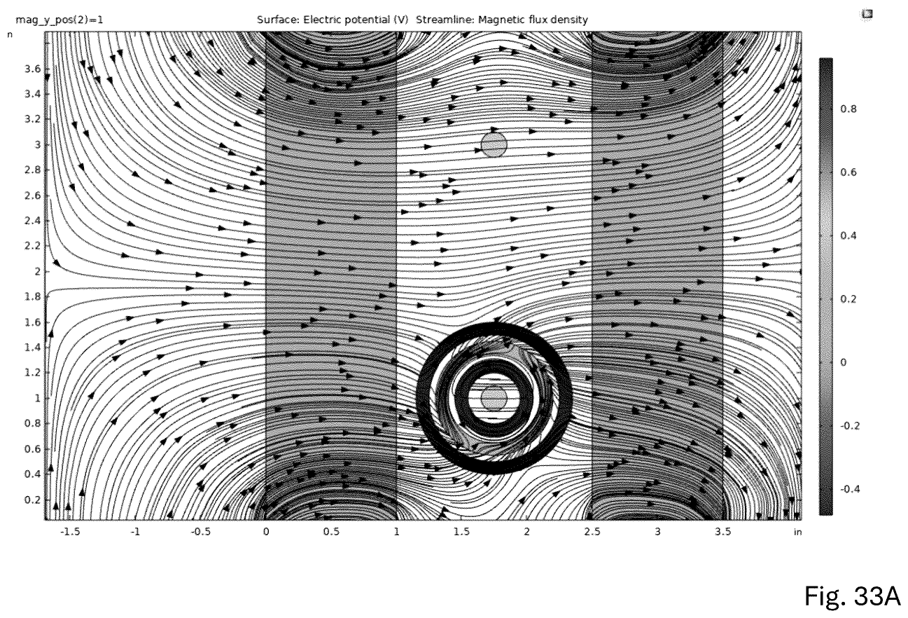

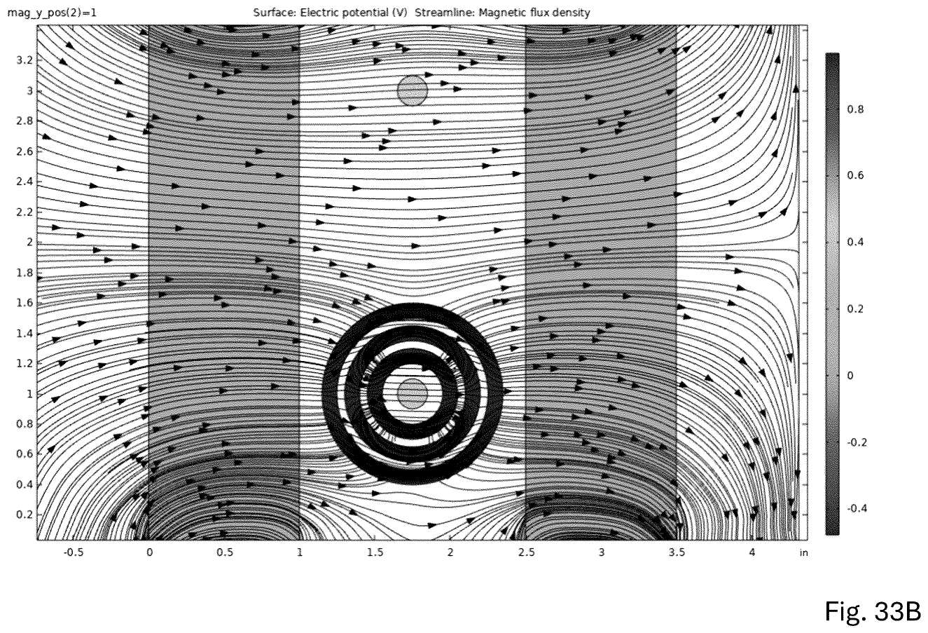

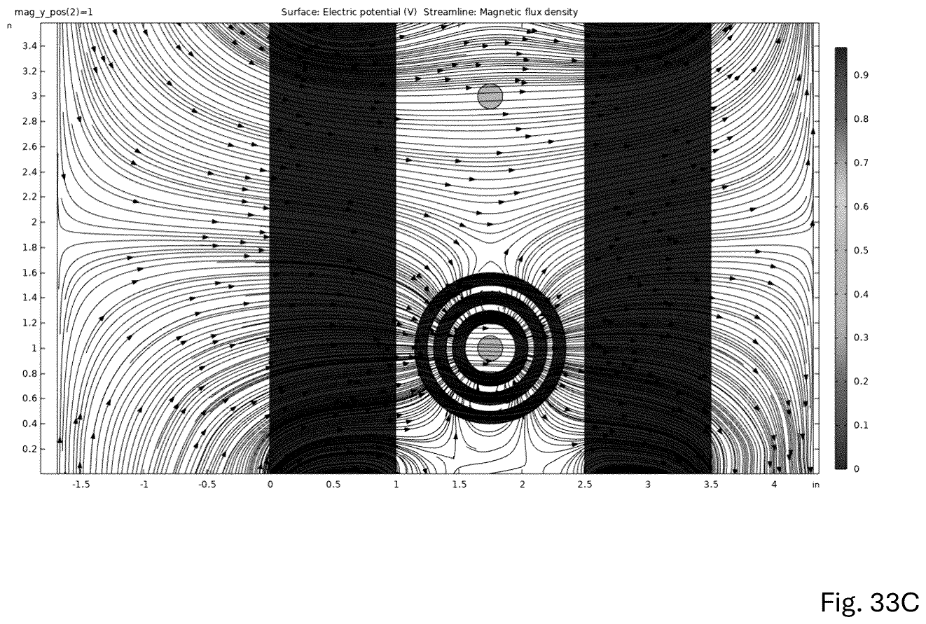

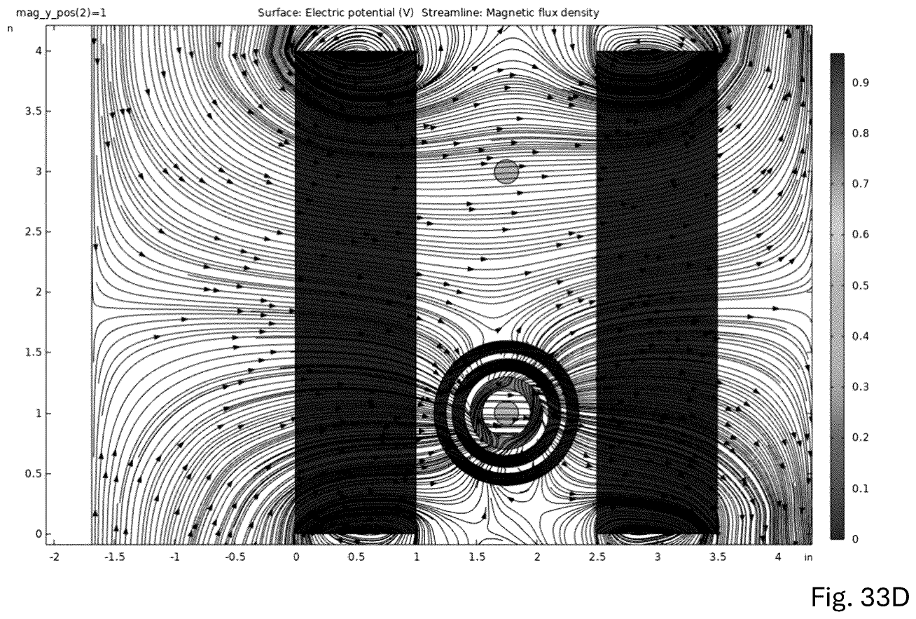

FIG. 33A includes three circular shielding magnets through which the conductor extends.
Electric Potential at position 1:
Shielded: 0.23836 V
Unshielded: 0.23111V

### Magnet Orientation:

Large Magnets: N right
Outer Ring Magnet: N right
Middle Ring Magnet: N up
Smaller Ring Magnet: N left
Shielding Impact: Significantly reduces electric potential.

With respect to FIG. 33B. Electric Potential at position 1:
Shielded: 0.23872 V
Unshielded: 0.22759 V

### Magnet Orientation:

Large Magnets: N right
Outer Ring Magnet: N Right
Middle Ring Magnet: N Left
Smaller Ring Magnet: N Right
Shielding Effect: The shielded potential is slightly higher than the unshielded potential, suggesting minimal shielding impact in this configuration.

With respect to FIG. 33C. Electric Potential at position 1:
Shielded: 0.23749 V
Unshielded: 0.21205V

### Magnet Orientation:

Large Magnets: N right
Outer Ring Magnet: N Right
Middle Ring Magnet: N down
Smaller Ring Magnet: N Right

With respect to FIG. 33D. Electric Potential at position 1:
Shielded: 0.23692 V
Unshielded: 0.20489V

### Magnet Orientation:

Large Magnets: N right
Outer Ring Magnet: N Right
Middle Ring Magnet: N Right
Smaller Ring Magnet: N Up

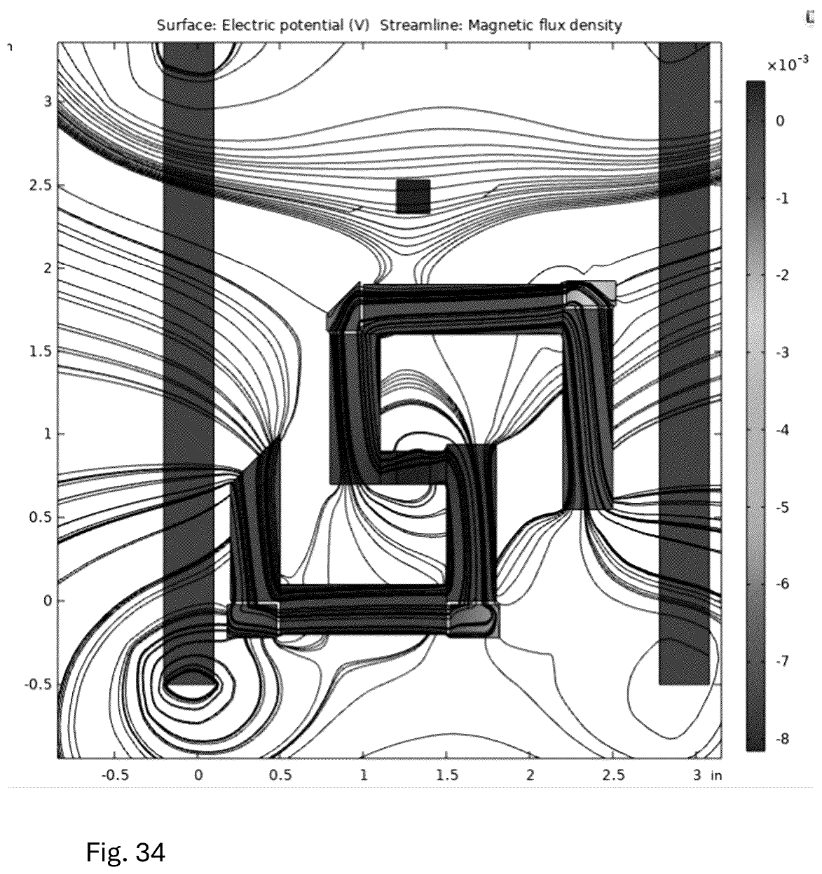

### FIG. 34. Materials:

Iron Corners: Enhance and direct magnetic fields.
Neodymium Blocks: Provide strong magnetic fields.
Unshielded Copper: 2.7784E-4 V
Shielded Copper: −0.0023140 V
Velocity: 2 m/s

### Hypothetical Results and Analysis.

### Unshielded Copper

2 m/s: 0.27784 mV
20 m/s: 2.7784 mV
Analysis: Higher velocity increases the potential due to greater induced voltage.

### Shielded Copper

2 m/s: −2.3140 mV
20 m/s: −23.140 mV
Analysis: Shielding remains effective, reducing potential even at higher velocities.
Velocity Impact: Unshielded copper shows increased potential with higher velocity, while shielding effectively lowers potential in shielded copper.

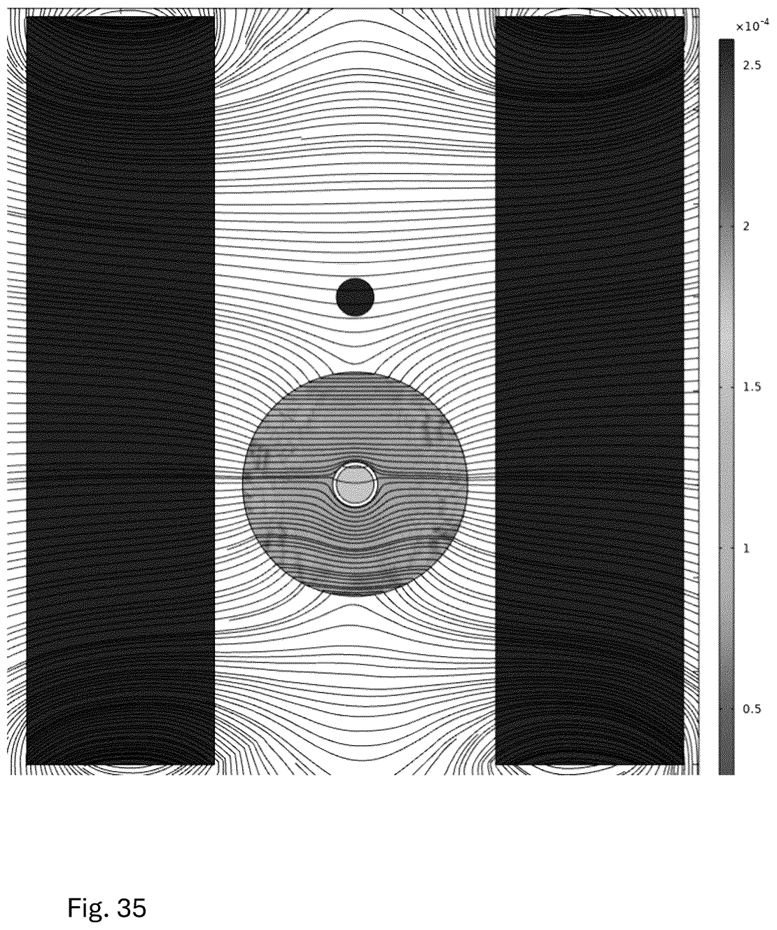

Test 5: FIG. 35. Shielding using iron tube around round wire of copper (North to the right on the big magnets)
Does create a small shielding effect, Voltage drops from 0.025 to 0.015

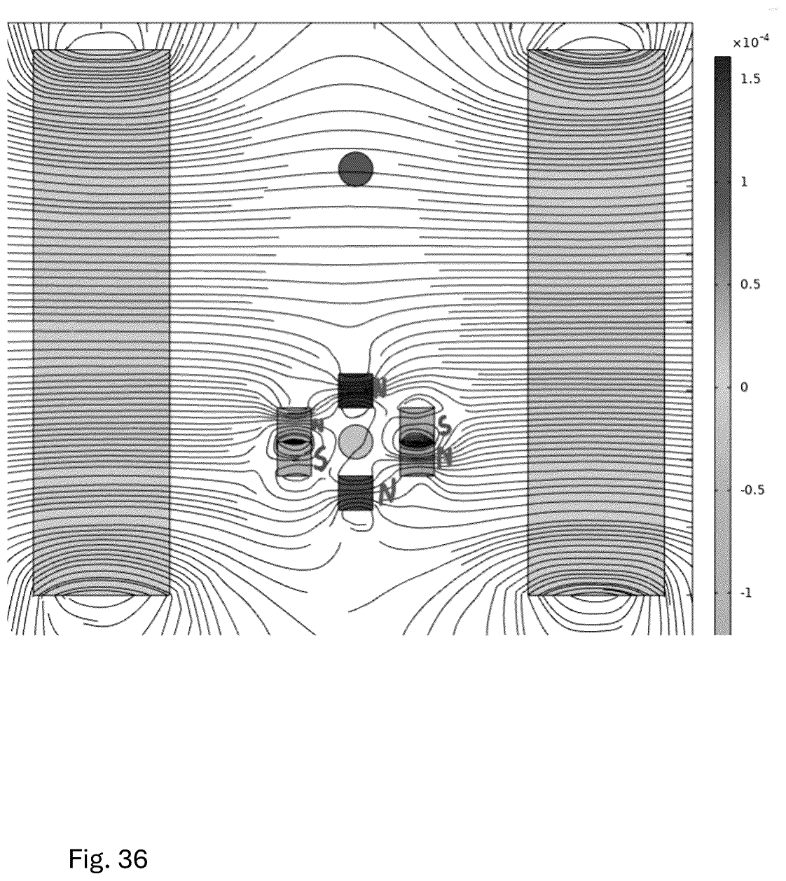

Test 6: FIG. 36. Six magnets around copper wire approaching a Halbach array configuration.
(North right on the large magnets, see FIG. 36 for polarity on 6 small ones). Not the best results. Visually creates a gap in flux density, but doesn't decrease voltage as much as other tests. This is also likely to be effective when reversing the Halbach array.
Reduces voltage from 22 mV to 5 mV. (4 fold reduction) The reduction in unshielded voltage is the result of spacing the large magnets further to better represent our physical test.

Test 7: Five magnets around copper block, in between two larger magnets. (North right on the large magnets, alternating polarity on each of the small magnets).
FEA showed decent results, but trying in a physical/non modeling scenario, didn't perform well at all at reducing induction. This could be because we used ferrite shielding magnets that were weaker than the field we were trying to shield against.

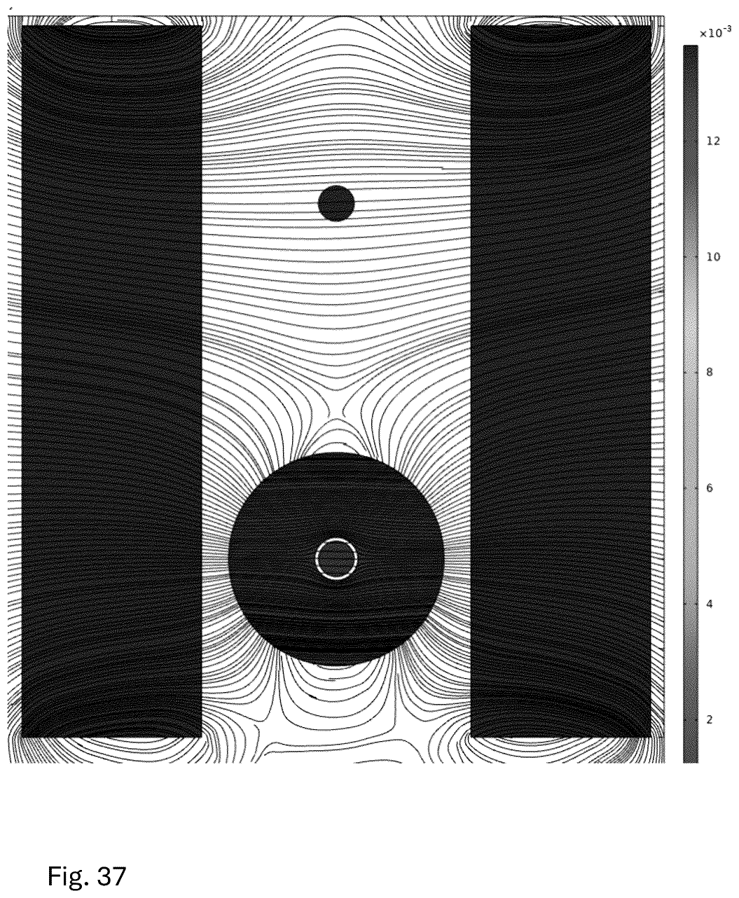

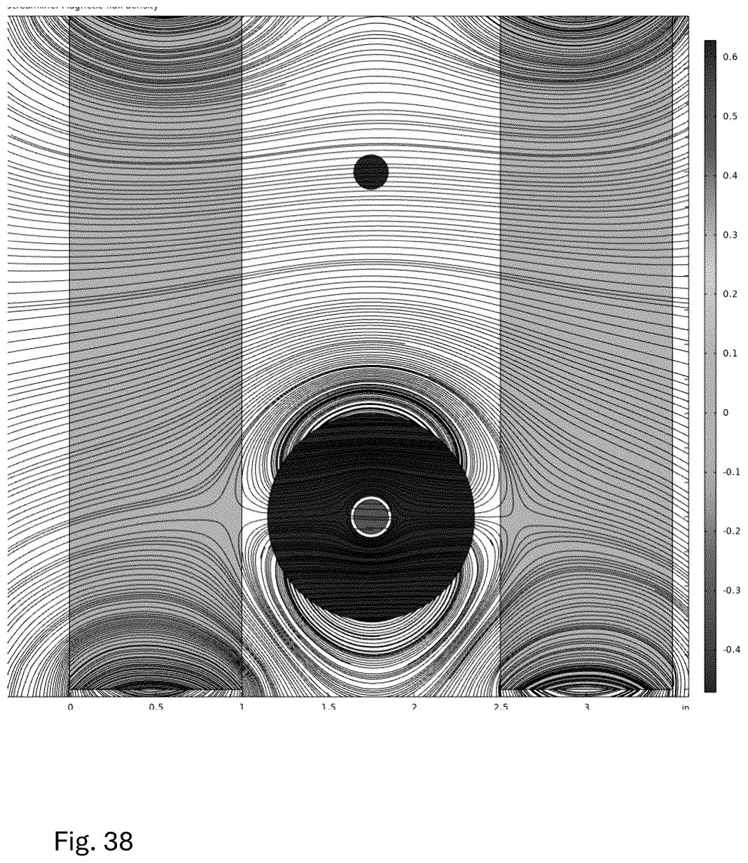

Test 8: FIGS. 37 and 38. Shielding using diametrically magnetized ring magnet around round wire of copper (North to the right on all magnets).
Shows a reduction in voltage from 30 mV to 0.7 mV (˜42× reduction).
Large magnets N right, ring magnet diametrically N Left. Same grades and strengths. Shows a reduction in Voltage, but not a reversal.
Unshielded 313 mV
Shielded 236 mV

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A homopolar dynamoelectric machine, comprising:
stator layers spaced radially apart from one another;
rotor layers provided between adjacent ones of the stator layers and rotatable through a fixed magnetic field generated by the stator layers;
electrical connectors to electrically connect axial ends of adjacent ones of the rotor layers in series, parallel, or a combination of series and parallel; and
at least one flux return mitigation assembly to interact with flux of the fixed magnetic field generated by the stator layers; wherein
a portion of one of the electrical connectors passes through an empty center portion of the at least one flux return mitigation assembly; and
the at least one flux return mitigation assembly includes magnetic structures extending between a gap between the stator layers that are spaced radially apart from one another.

2. The homopolar dynamoelectric machine according to claim 1, wherein the rotor layers and the stator layers are integrally connected to be rotatable together about a central axis.

3. The homopolar dynamoelectric machine according to claim 1, wherein the at least one flux return mitigation assembly includes a series of permanent magnets which are spaced to create an inter-magnet field in the gap between the stator layers that are spaced radially apart from one another.

4. The homopolar dynamoelectric machine according to claim 3, wherein the series of permanent magnets includes at least one semicircular magnet and at least one straight magnet.

5. The homopolar dynamoelectric machine according to claim 1, wherein the magnetic structures include both permanent magnets and iron portions.

6. The homopolar dynamoelectric machine according to claim 1, wherein the at least one flux return mitigation assembly includes at least two individual paired magnets rotatable together with the electrical connectors, the electrical connectors passing through a gap between the at least two individual paired magnets.

7. The homopolar dynamoelectric machine according to claim 1, wherein the at least one flux return mitigation assembly includes two of the at least one flux return mitigation assemblies located on opposing axial ends of the homopolar dynamoelectric machine.

8. The homopolar dynamoelectric machine according to claim 1, wherein
the at least one flux return mitigation assembly includes a radially extending hole through which another portion of the one of the electrical connectors adjacent to the portion of the one of the electrical connectors passes.

9. The homopolar dynamoelectric machine according to claim 8, wherein
the magnetic structures are symmetrical or substantially symmetrical about the empty center portion.

10. The homopolar dynamoelectric machine according to claim 9, wherein
the magnetic structures include a pair of straight portions and a pair of arc-shaped portions.

11. The homopolar dynamoelectric machine according to claim 10, wherein
the pair of straight portions include individual magnets and the pair of arc-shaped portions include multiple wedge-shaped magnets.

12. The homopolar dynamoelectric machine according to claim 11, wherein a radially extending hole through which another portion of the one of the electrical connectors adjacent to the portion of the one of the electrical connectors passes through only some of the multiple wedge-shaped magnets.

13. The homopolar dynamoelectric machine according to claim 1, wherein
the at least one flux return mitigation assembly includes radial magnets provided at opposing axial ends of a hollow tube which supports the rotor layers and the stator layers.

14. The homopolar dynamoelectric machine according to claim 1, wherein
the stator layers include permanent magnets to generate the fixed magnetic field; and
the rotor layers include conductive portions that are rotatable through the fixed magnetic field to produce an electric current.

15. The homopolar dynamoelectric machine according to claim 1, wherein the stator layers are fixed to the rotor layers with electrically insulating material provided therebetween.

16. The homopolar dynamoelectric machine according to claim 1, wherein a radially inner one of the stator layers has stronger magnetic properties than a radially outer one of the stator layers.
